(19) United States
(12) Patent Application Publication
(10) Pub. No.: US 2004/0191706 A1
(43) Pub. Date: Sep. 30, 2004

(54) Silver halide color photographic light sensitive material for image capture and color image forming method

(75) Inventors: Masaru Iwagaki, Tokyo (JP); Kuniaki Uezawa, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONIKA MINOLTA HOLDINGS, INC.

(21) Appl. No.: 10/806,164

(22) Filed: Mar. 23, 2004

(30) Foreign Application Priority Data
Mar. 26, 2003 (JP) JP2003-084066

(51) Int. Cl. G03C 1/46

(52) U.S. Cl. 430/505

(57) ABSTRACT

A silver halide color photographic light sensitive material for image capture comprising a transparent substrate having on one surface thereof, a red light-sensitive layer unit, a green light-sensitive layer unit and a blue light-sensitive layer unit, each of the light-sensitive layer unit having at least 2 layers of the same spectral sensitivity but a different light sensitivity, and the specific photographic sensitivity of the light sensitive material is 320 or more,

wherein the light sensitive material produces an image after having been exposed and subjected to development processing, the image having characteristic curves of color images formed in the red light-sensitive layer unit, in the green light-sensitive layer unit or in the blue light-sensitive layer unit, the characteristic curves satisfying a gradient (γ) Requirement.

### TECHNICAL FIELD

The present invention relates to a silver halide color photographic light sensitive material for image capture (hereafter, also referred to as a photographic material) and a method for forming color images, and in particular to a silver halide color photographic material for image capture which is easily read with a scanner and easily converted to digital image information, and to a method for forming color images to obtain high quality color images.

### BACKGROUND

Heretofore, as a photographic material for image capture to obtain color prints, mainly employed has been color negative film. Widely employed is a nega-posi photographic system which comprises the steps of development of a color negative film after exposure and then printing the obtained color image onto color print paper to obtain a color print.

With this system, it is possible to obtain extremely high quality prints. On the other hand, since it requires development processing of photographic color paper, in addition to that of a color negative film, to obtain color prints from a color negative film after image capture, many processes and much time are required. Thus, the system has major drawbacks of not only lacking speed but also requiring a color paper development process.

In the meantime, digital still cameras which have gotten a lot of attention recently, capture image information which is recorded as digital information, and thus, it is possible to obtain a color hard copy (such as a color print and an ink-jet print) of the image within a few minutes with any appropriate means after image capture. However, the present situation is that quality of these obtained prints using a general digital still camera is very unsatisfactory compared to that of conventional color prints.

Consequently, required is development of a system which can provide digitalized image information and high quality color prints in a short amount of time, using a silver halide color photographic light sensitive material for image capture and avoiding photographic color print paper.

As methods to read image information using a scanner after development of a silver halide color photographic material for image capture, commonly known are the methods described in unexamined Japanese Patent Application Publication (hereinafter, referred to as JP-A) Nos. 5-100321, 9-121265, 9-146247, 9-230557, 9-281675, 11-52526, 11-52527, 11-52528 and 11-65051, and U.S. Pat. Nos. 5,101,286, 5,113,351, 5,627,016 and 5,840,470. However, these methods are not sufficient in terms of stability and speed of development processing, and production of waste material such as a processing sheet.

At the same time, various proposals have been made regarding gradation characteristics and spectral sensitivity characteristics of silver halide color photographic light sensitive materials for image capture. For example, proposed is a silver halide color photographic material, the straight line gradient of which is determined by the least square method from the primary differential values of the characteristic curves of each of a red light-sensitive layer, a green light-sensitive layer and a blue light-sensitive layer within a certain range; and the relationship of sensitivities of the green light-sensitive silver halide emulsion layer and the red light-sensitive silver halide emulsion layer is set within a specific condition; and the sensitivities of which are determined with uniform exposure by white light and with monochromatic light of 560 nm; resulting in no quality deterioration after printing, specifically when using fluorescent lamps. (For example, refer to Patent Document 1.) Further, proposed is a silver halide color photographic material which provides a satisfactory quality print when image capture is performed under various regions of brightness from cloudy day light to clear bright weather, under the condition in which regions of more than 0.4 in point gamma (d D/d Log E) of density function curve D (Log E) of all of blue, green and red are provided at more than 2.8 in Log E. (Refer, for example, to Patent Document 2.) However, in recent years neither method has exhibited sufficient desired effects in preparation of a color print by reading image information using a color scanner.

Further, in cases when a typical silver halide color photographic material for image capture is employed as a material for scanner reading, since it is essentially designed for use in printing onto color print paper, colored couplers for masking and dyes for adjusting the minimum densities affect to reduce the S/N ratio during reading, and when the exposure conditions during image capture are either under or over exposure, the photographic material is said to not necessarily have sufficient scanner readable capability, resulting in the present situation of not exhibiting enough advantages as a system.

Further, the conventional silver halide color photographic material for image capture has drawbacks of causing image blur when providing graininess enhanced processing, or causing deterioration of granularity when providing sharpness enhancement to obtain sharper images, during image processing process after reading with a scanner. Further, to convert to desirable digital image data, many image processing is required, resulting in requirement of huge memory storage per image. In cases when conducting this processing, expensive apparatuses are required, and time for processing and transfer of digital image data is also required, resulting in decrease of productivity in photo finishing labs.

Patent Document 1: JP-A 5-72683 (Claims)

Patent Document 2: JP-A 6-258787 (Claims)

Consequently, an object of the present invention is to provide a silver halide color photographic light sensitive material for image capture which is superior in image reading capability using a general purpose scanner, after which the read image information is easily converted to digital data, resulting in high quality color prints, and another object is to provide a method for forming color images by which excellent color images can be formed, exhibiting sufficient performance on silver halide photographic material for image capture.

### SUMMARY

The above object of the present invention can be accomplished by the following constitutions.

1. A silver halide color photographic light sensitive material for image capture comprising a transparent substrate having on one surface thereof, a red light-sensitive layer unit, a green light-sensitive layer unit and a blue light-sensitive layer unit, each light-sensitive layer unit having at least 2 layers of the same spectral sensitivity but having a different light sensitivity, and a specific photographic sensitivity of the light sensitive material is 320 or more,

wherein the light sensitive material produces an image after being exposed and being subjected to a development processing, the image has characteristic curves of color images formed in the red light-sensitive layer unit, the green light-sensitive layer unit or the blue light-sensitive layer unit satisfies Requirement 1, and each of a minimum transmission density of red, green and blue light is independently 0.20 or less:

Requirement 1, each of γR₁, γR₂, γG₁, γG₂, γB₁ and γB₂ being 0.8 or more and 1.3 or less, and each of |γR₁−γG₁|, |γG₁−γB₁|, |γR₁−γB₁|, |γR₂−γG₂|, |γG₂−γB₂|, and |γR₂−γB₂| being 0.1 or less,

wherein each of γR₁, γG₁ and γB₁ and is gradient of a straight line connecting a point having a density of 0.30 above the minimum transmission density and a point having a density of 1.50 above the minimum transmission density in the red, green and blue light-sensitive layer units respectively, and

each of γR₂, γG₂ and γB₂ is gradient of a straight line connecting a point having a density of 1.50 above the minimum transmission density and a point having a density of 2.50 above the minimum transmission density in the red, green and blue light-sensitive layer units respectively.

2. The silver halide color photographic light sensitive material for image capture comprising a transparent substrate having on one surface thereof, a red light-sensitive layer unit, a green light-sensitive layer unit and a blue light-sensitive layer unit, each light-sensitive layer unit having at least 2 layers of the same spectral sensitivity but having a different light sensitivity, and a specific photographic sensitivity of the light sensitive material is 320 or more,

wherein the light sensitive material produces an image after being exposed and being subjected to a development processing, the image has characteristic curves of color images formed in the red light-sensitive layer unit, the green light-sensitive layer unit or the blue light-sensitive layer unit satisfies Requirement 1, and further each of the maximum transmission density of red, green and blue light is independently 2.80-3.80.

3. The silver halide color photographic light sensitive material for image capture comprising a transparent substrate having on one surface side thereof, a red light-sensitive layer unit, a green light-sensitive layer unit and a blue light-sensitive layer unit, each light-sensitive layer unit having at least 2 layers of the same spectral sensitivity but a different light sensitivity, and a specific photographic sensitivity of the light sensitive material is 320 or more,

wherein the light sensitive material produces an image after being exposure and being subjected to a development processing, the image has characteristic curves of color images formed in the red light-sensitive layer unit, the green light-sensitive layer unit or the blue light-sensitive layer unit satisfies Requirement 1, and further a spectral absorption maximum of a colored dye formed from a coupling reaction of a cyan coupler contained in the red light-sensitive layer unit with an oxidized aromatic primary amine color developing agent is 630 to 670 nm.

4. The silver halide color photographic light sensitive material for image capture comprising a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 320 or more,

wherein the light sensitive material produces an image after being exposed and being subjected to a development processing, the image has characteristic curves of color images formed in the red light-sensitive layer unit, the green light-sensitive layer unit or the blue light-sensitive layer unit satisfies Requirement 1, and further color separation exposure gradations of γR, γG and γB and white light exposure gradation of γWR, γWG and γWB satisfy Requirement 2:

Requirement 2, each of γR/γWR, γG/γWG and γB/γWB being 1.0 or more and 1.05 or less,

wherein each of γR, γG and γB indicates gradient of a straight line connecting a point having a density of 0.30 above the minimum transmission density and that of 0.15 above the minimum transmission density in each of the red, green and blue light-sensitive layer units, each of which straight lines is obtained by color separation exposure of red, green and blue respectively, and

each of γWR, γWG and γWB indicates gradient of a straight line connecting a point having a density of 0.30 above the minimum transmission density and a point having a density of 1.50 above the minimum transmission density in each of the red light-sensitive layer unit, green light-sensitive layer unit and blue light-sensitive layer unit respectively, each of which straight lines is obtained by white light exposure.

5. The silver halide color photographic light sensitive material for image capture according to any one of Items 1-4 above, wherein each of characteristic curves of color images formed in the red light-sensitive layer unit, the green light-sensitive layer unit or the blue light-sensitive layer unit satisfies the following Requirement 3:

Requirement 3: each of γR3, γG3 and γB3 is 0.8 or more and 1.3 or less,

wherein each of γR₃, γG₃ and γB₃ is gradient of a straight line connecting a point having a density of 0.70 above the minimum transmission density and a point having a density of 2.00 above the minimum transmission density in the red, green and blue light-sensitive layer unit respectively.

6. A method for forming color images for obtaining color prints from outputted digital images after the silver halide color photographic light sensitive material for image capture has been exposed and development processed, followed by digital image conversion,

wherein after exposure and development processing, each of the characteristic curves of color images formed in the red light-sensitive layer unit, the green light-sensitive layer unit and the blue light-sensitive layer unit satisfies the foregoing Requirement 1, and further, digital image data conversion is conducted using a method comprising the steps of:

(i) providing shading correction, pixel sensitivity correction and dark current correction to the outputted signals in proportion to the amount of transmitted light, and

(ii) converting the corrected signals to signals in proportion to image luminance using nonlinear conversion.

7. The method for forming color images according to Item 6 above, wherein the foregoing silver halide color photographic light sensitive material for image capture is any one of described Items 1-5.

In the present invention, as a result of diligent investigation in view of the above cited problems, the inventors obtained results toward the invention of a silver halide color photographic light sensitive material for image capture which is superior in image reading capability using a general purpose scanner, so that the read image information is easily converted to digital data, and obtained color prints from which are of high quality. The silver halide color photographic light sensitive material for image capture comprises a transparent substrate having on one side thereof, a red light-sensitive layer unit, a green light-sensitive layer unit and a blue light-sensitive layer unit. All units of which have at least two layers of the same spectral sensitivity but different light sensitivity, having a specific photographic sensitivity of 320 or more,

wherein after exposure and development processing, each of the characteristic curves of color images formed in the red light-sensitive layer unit, the green light-sensitive layer unit or the blue light-sensitive layer unit satisfies the foregoing Requirement 1, and further:

a. each of the minimum transmission density of red, green and blue light is 0.20 or less,

b. each of the maximum transmission density of red, green and blue light is 2.80-3.80,

c. the spectral absorption maximum of a colored dye resulting in coupling of a cyan coupler contained in the red light-sensitive layer unit with an aromatic primary amine color developing agent is 630 to 670 nm, or

d. color separation exposure gradations of γR, γG and γB and white light exposure gradation of γWR, γWG and γWB satisfy the foregoing Requirement 2.

Further, the inventors obtained results toward the invention of a color image forming method obtaining a color print from outputted digital images after the silver halide color photographic light sensitive material for image capture is exposed and development processed, followed by digital image conversion, wherein each of the characteristic curves of the color images formed in the red, green and blue light-sensitive layer units satisfies foregoing Requirement 2, and the digital image data is converted to signals in proportion to image luminance with nonlinear conversion, after the outputted signals in proportion to transmitted light volume are subjected to shading correction, pixel sensitivity correction and dark current correction, resulting in a color image forming method enabling formation of excellent color images, and further resulting in sufficiently high performance of the silver halide photographic material for image capture.

### DESCRIPTION OF THE PREFERRED EMBODIMENTS

The present invention will now be further detailed. The silver halide color photographic light sensitive material for image capture of this invention is characterized by exhibiting specific photographic sensitivity of 320 or more.

Specific photographic sensitivity of the silver halide color photographic material for image capture of this invention is determined based on the following test method according to ISO sensitivity. [based on JIS K 7614-1981, (JIS=Japanese Industrial Standards)]

(1) Test conditions: Tests were conducted in a room at 20±5° C., 60±10% RH, and photographic materials to be tested were stored under this conditions for more than 1 hr.

(2) Exposure: The relative spectral energy distribution of standard light at the exposure surface satisfies the following:

| | Relative | | Relative |
|---|---|---|---|
| Wavelength | spectral | Wavelength | spectral |
| (nm) | energy(1*) | (nm) | energy |
| 360 | 2 | 370 | 8 |
| 380 | 14 | 390 | 23 |
| 400 | 45 | 410 | 57 |
| 420 | 63 | 430 | 62 |
| 440 | 81 | 450 | 93 |
| 460 | 97 | 470 | 98 |
| 480 | 101 | 490 | 97 |
| 500 | 100 | 510 | 101 |
| 520 | 100 | 530 | 104 |
| 540 | 102 | 550 | 103 |
| 560 | 100 | 570 | 97 |
| 580 | 98 | 590 | 90 |
| 600 | 93 | 610 | 94 |
| 620 | 92 | 630 | 88 |
| 640 | 89 | 650 | 86 |
| 660 | 86 | 670 | 89 |
| 680 | 85 | 690 | 75 |
| 700 | 77 | | |

Note
(1*): Values are determined based on normalization of the value at 560 nm being 100.

Illumination variation at the exposed surface is conducted using an optical wedge, the spectral transparent density of which varies within 10% in the range of 360—less than 400 nm and within 5% in 400 and more—700 nm, with the exposure time being 1/100 sec.

(3) Development processing: The test samples were stored at 20±5° C., 60±10% RH during exposure and development processing.

Development processing is completed within 30-60 min. after exposure. Development processing is conducted using the C-41 Processing developed by Eastman Kodak Company and described in The British Journal of Photography Annual 1988, pp. 196-198.

(4) Density measurement: Density is indicated by Log₁₀ (φO/φ), where φO is illumination flux, and φ is transmission flux at the measured portions. Geometrical conditions of density measurement are that illumination flux is a parallel flux to the normal line direction, the total flux being defused into a half space after transmitted as transmission flux and used as a standard, and correction using standard density samples is conducted when other measurement methods are employed. Further, the emulsion surface faces a sensor device. In density measurement, each Status M density of blue, green and red is measured, and the spectral characteristics are adjusted to exhibit the values described in Tables 1 and 2 as a comprehensive characteristics of the light source, the optical system and the optical filters used for the densitometer, and the sensor device.

TABLE 1
Spectral characteristics of Status M density
(indicated as logarithms, normalized at the peak being 5.00)

| Wavelength | | | |
|---|---|---|---|
| nm | Blue | Green | Red |
| 400 | −0.40 | −6.29 | −55.1 |
| 410 | 2.10 | −5.23 | −52.5 |
| 420 | 4.11 | −4.17 | −49.9 |
| 430 | 4.63 | −3.11 | −47.3 |
| 440 | 4.37 | −2.05 | −44.7 |
| 450 | 5.00 | −0.99 | −42.1 |
| 460 | 4.95 | 0.07 | −39.5 |
| 470 | 4.74 | 1.13 | −36.9 |
| 480 | 4.34 | 2.19 | −34.3 |
| 490 | 3.74 | 3.14 | −31.7 |
| 500 | 2.99 | 3.79 | −29.1 |
| 510 | 1.35 | 4.25 | −26.5 |
| 520 | −0.85 | 4.61 | −23.9 |
| 530 | −3.05 | 4.85 | −21.3 |
| 540 | −5.25 | 4.98 | −18.7 |
| 550 | −7.45 | 4.98 | −16.1 |
| 560 | −9.65 | 4.80 | −13.5 |
| 570 | −11.9 | 4.44 | −10.9 |
| 580 | −14.1 | 3.90 | −8.29 |
| 590 | −16.3 | 3.15 | −5.69 |

TABLE 2

| Wavelength | | | |
|---|---|---|---|
| nm | Blue | Green | Red |
| 600 | −18.5 | 2.22 | −3.09 |
| 610 | −20.7 | 1.05 | −0.49 |
| 620 | −22.9 | −0.15 | 2.11 |
| 630 | −25.1 | −1.35 | 4.48 |
| 640 | −27.3 | −2.55 | 5.00 |
| 650 | −2.95 | −3.75 | 4.90 |
| 660 | −31.7 | −4.95 | 4.58 |
| 670 | −33.9 | −6.15 | 4.25 |
| 680 | −36.1 | −7.35 | 3.88 |
| 690 | −38.3 | −8.55 | 3.49 |
| 700 | −4.05 | −9.75 | 3.10 |
| 710 | −42.7 | −10.9 | 2.69 |
| 720 | −44.9 | −12.2 | 2.27 |
| 730 | −47.1 | −13.4 | 1.86 |
| 740 | −49.3 | −14.6 | 1.45 |
| 750 | −51.5 | −15.8 | 1.05 |

(5) Determination of specific photographic sensitivity: Using the results obtained after processing and density measurement under the conditions described in (1)-(4), specific photographic sensitivity was determined by the following procedure. To each minimum density of blue, green and red, exposure amount corresponding to a 0.15 higher density is indicated as lux·sec., and each of them is designated HB, HG and HR respectively. A larger value indicating lower sensitivity) of HB and HR is designated HS.

Specific photographic sensitivity is calculated employing the following equation.

S=(2/HG×HS)^{1/2}

In this invention, specific photographic sensitivity determined using the above method is characterized by a value of not less than 320, and preferably between 320 and 3,200 inclusively.

In the silver halide color photographic light sensitive material for image capture of the present invention, it is characterized by that each of the characteristic curves of the color images formed by color development processing in the red, green and blue light-sensitive layer units satisfies the foregoing Requirement 1.

The characteristic curves of this invention are referred to as density function curves, which are so-called D-Log H curves, plotted as a common logarithm of exposure amount H (as Log H) on the horizontal axis, and density D on the vertical axis. It is a D-Log E curve, for example, detailed in “The Theory of the Photographic Processing” 4^{th} ed., edited by T. H. James, on pp. 501-509, Macmillan Publishing Co., Inc., New York, 1977. Usually, 1.0 of ΔLog H and 1.0 of ΔD are configured at even intervals.

Measurement of the transmission density of each of color images formed by color development processing in the red, green and blue light-sensitive layer units, is conducted with no limitations, but in this invention, the transmission density is measured with red light, green light and blue light respectively, using a transmission densitometer, model 310T manufactured by X-Rite Inc. The obtained density value is the transmission density.

Firstly, Requirement 1 defined in this invention will be described.

One of the requirements defined by Requirement 1 of this invention is that each of γR₁, γR₂, γG₁, γG₂, γB₁ and γB₂ is 0.8-1.3 inclusive, preferably 0.8-1.2 inclusive, and more preferably 0.9-1.2 inclusive.

Further, the second requirement is that the difference of gradient (γ) between each of the light-sensitive layer units (between the red light-sensitive layer unit and the green light-sensitive layer unit, the green light-sensitive layer unit and the blue light-sensitive layer unit, and the red light-sensitive layer unit and the blue light-sensitive layer unit) is in each case 0.1 or less.

This means that the gradient of each of the color images in the red light-sensitive layer unit, the green light-sensitive layer unit and the blue light-sensitive layer unit exhibits rather high contrast from the low density regions to the principal gradation regions, being from the point having a density of 0.03 above the minimum transmission density to the point having a density of 1.50 above the minimum density, and also from the principal gradation regions to the high density regions, being from the point having a density of 1.50 above the minimum transmission density to the point having a density of 2.50 above the minimum transmission density, and incidentally the degrees of gradient among the three light-sensitive units are approximated.

The silver halide color photographic light sensitive material for image capture of this invention preferably satisfies the foregoing Requirement 3, in addition to the foregoing Requirement 1 described above.

Requirement 3 defined in this invention means that each gradient (γ) of color images in the red light-sensitive layer unit, the green light-sensitive layer unit and the blue light-sensitive layer unit is in the range of 0.8-1.3 in the density region from the point having a density of 0.70 above the minimum transmission density to the point having a density of 2.00 above the minimum transmission density, where is so-called the principal gradation region.

The silver halide color photographic light sensitive material for image capture comprising the gradient and the gradation balance, which are defined above, is superior in image reading capability using a general purpose scanner, and the read image information is easily converted to digital data, resulting in the likelihood to obtain high quality color prints.

In the silver halide color photographic light sensitive material for image capture of this invention, a method to achieve the conditions described above in the red light-sensitive layer unit, the green light-sensitive layer unit and the blue light-sensitive layer unit is not specifically limited. For example, the curve may be approximated by obtaining a layer configuration of more than 2 layers having the same spectral sensitivity but different light sensitivity, and further, as the design of the dominant layer comprising gradient of the lower sensitivity region, by employing (1) enhanced higher light sensitivity, or (2) increased gradation, compared to the straight line type moderate gradient of conventional silver halide color photographic material for image capture (having a gradient of 0.50-0.80). For example, as a concrete measure to achieve item (1), it is possible to increase the average particle diameter of the used silver halide emulsion, or to enhance the efficiency of chemical sensitization or spectral sensitization, while to achieve item (2), it is possible to enhance the monodispersion degree of the silver halide emulsion or to enhance uniformity of chemical sensitization and spectral sensitization to silver halide particles.

In the silver halide color photographic material of this invention, one of the characteristics is that the minimum transmission density value of each light-sensitive layer unit is that neither is more than 0.20, in addition to Requirement 1 described above. One way to keep the minimum transmission density value at not more than 0.20, is to decrease colored couplers for masking which are employed in conventional silver halide color photographic material for image capture, or by decreasing fogging caused by the silver halide emulsions. In cases when the amount of colored couplers is reduced, the masking effects are also reduced, but can easily be complemented by image processing computation during digital image data conversion, enabling compensation of the effects of the resulting images. Further, reduction of fogging by silver halide emulsions can be achieved by use of well-known techniques basically with no limitation. Further, as mentioned later, in cases when a development inhibitor releasing compound is reduced from currently employed levels, reduction of fogging can be easily achieved because sensitivity load imposed on the silver halide emulsion is also decreased.

In the photographic material for image capture of this invention, the added amount of colored couplers is decreased or completely eliminated, but in cases when even a small amount of these is used, any couplers within the public domain may be employed. Examples of specifically usable colored magenta couplers and colored cyan couplers include colored magenta couplers represented by Formulas (I) and (II), and colored cyan couplers represented by Formulas (III), (IV) and (V), described in JP-A 10-3144.

In the silver halide color sensitive material for image capture of this invention, one characteristic is the maximum transmission density value of each light-sensitive layer unit being each 2.80-3.80, in addition to Requirement 1 described above.

The silver halide photographic material for image capture having the foregoing high maximum transmission density in addition to the gradient and gradation balance defined in Requirement 1, exhibits a wide dynamic range in the high density region, and specifically exhibits a high gradient into the high density region, resulting in decreasing loss of gradient in high-lighted areas, and providing superior reading aptitude using a general purpose scanner, and also providing ease of digital conversion of the read image information. As a result, high quality color prints result.

In the silver halide color photographic light sensitive material for image capture of this invention, the method to achieve the foregoing maximum transmission density in the red light-sensitive layer unit, the green light-sensitive layer unit and the blue light-sensitive layer unit is not specifically limited, but a desired maximum transmission density may be obtained by accordingly selecting methods such as a method to make the configuration of each of the light-sensitive units a plurality of layer configuration of more than two layers and to adjust the added amount of couplers or silver halide emulsions, or to employ a highly developable coupler, which are employed in a lower photo-sensitive layer mainly taking on reproduction in high-lighted area.

In the silver halide color photographic light sensitive material for image capture of this invention, one of characteristics is that the spectral absorption maximum of the colored dye, formed by coupling of a cyan coupler contained in the red light-sensitive layer unit with an aromatic primary amine color developing agent, is 630-670 nm. By employing the cyan coupler exhibiting the above characteristic, the objects and effects of this invention are further maximized.

In this invention, a method to realize the spectral absorption maximum of the cyan colored dye being in the range of 630-670 nm is by selecting at least one from the several choices of specific cyan couplers, the choice of a specific aromatic primary amine color developing agent and control of the existing status of the colored dyes. Regarding the aromatic primary amine color developing agent, however, in cases when the silver halide photographic material is designed to be subjected to photographic processing generally by photofinishing laboratories, the color developing agent used in such photofinishig laboratories is inevitably selected.

As such specific cyan couplers, preferred are 2,5-diacylaminophenol type cyan couplers (hereinafter, also referred to as DAC type cyan couplers), pyrazoloazole type cyan couplers and pyroloazole type cyan couplers, of the well-known cyan couplers for color photography.

AS DAC type cyan couplers, preferred are ones described in JP-A 2001-228587, European Patent Nos. 1,197,798 and 1,191,396, JP-A 2000-321734 and U.S. Pat. No. 6,190,851.

As pyrazoloazole type cyan couplers, preferred are ones described in, for example, JP-A Nos. 2000-89421, 9-50101, 9-50100, 9-34068, 64-554, 63-250649 and 63-250650, and U.S. Pat. Nos. 5,658,720 and 5,679,506.

As pyroloazole type cyan couplers, preferred are ones described in, for example, JP-A Nos. 2002-174885, 2002-162717, 2002-107881, 2002-107882, 2002-107883, 2002-107884, 2002-107885, 2001-342189, 9-189988, and 10-198012; European Patent Nos. 491,197A, 488,248, 545,300, 628,867A1, and 484,909; U.S. Pat. No. 5,164,289, and JP-A 6-347960.

Further, in this invention, even cyan couplers other than those of the above three types of cyan couplers can provide the spectral absorption maximum in the range of 630-670 nm by control of the existing status of the colored dyes.

For example, in cases when 2-ureido-phenol type cyan couplers are added using phosphoric ester type high boiling point organic solvents, the spectral absorption maximum of the colored dyes can result to be in the range of 630-670 nm.

As ureido type cyan couplers, preferred are ones described in, for example, JP-A Nos. 7-234484, 56-65134, 57-204543, 57-204544, 57-204545, 60-108217, 59-105644, 59-111643, 59-111644, 63-159848, 63-161450 and 63-161451.

As phosphoric ester type high boiling point organic solvents combined with the above ureido type cyan couplers to exhibit the desired effects of this invention, solvents in the public domain may be employed with no limitations.

The silver halide color photographic light sensitive material for image capture of this invention is characterized by satisfying the foregoing Requirement 2, in addition to Requirement 1 described above.

In the silver halide color photographic light sensitive material for image capture of this invention, color separation exposure gradation of γR, γG and γB and white light exposure gradation of γWR, γWG and γWB being in a specific relationships defined by the foregoing Requirement 2 means the state in which the so-called inter-image effect is small or cannot be recognized, which effect is usually relatively large in conventional silver halide color photographic light sensitive material for image capture.

In addition, the color separation exposure gradation is the gradation resulting from development processing after separate exposures with only light rays sensitizing each light sensitive layer unit. The color separation exposure is usually conducted using a standard white light source with a wedge type filter and a red, green or red filter. In cases when Wratten filters, produced by Eastman Kodak Company, are employed, a No. 26 filter for red light exposure, a No. 99 filter for green light exposure and a No. 98 filter for blue light exposure are commonly used.

Further, the white light exposure gradation means gradation resulting from development processing after exposure using the foregoing standard white light source with the wedge type filters.

The gradations used for evaluation of the color separation exposure gradations and the white light exposure gradations are each point gamma values at the center point of maximum transmission density and minimum transmission density of the characteristic curves. In conventional silver halide photographic sensitive material for image capture, the ratio of the color separation exposure gradation to the white exposure gradation is quite large, generally being within a range of 1.2-1.5.

To achieve such relationships between color separation exposure gradation and the white light exposure gradation of this invention, it is effective to employ a method to reduce or eliminate development inhibitor releasing compounds which are widely used in conventional silver halide color photographic sensitive material for image capture, or to control halogen compositions of the silver halide emulsion. By employing these configurations, a condition with a little or no inter-image effect is realized.

To achieve a ratio of the color separation exposure gradation to the white light exposure gradation within the preferable range, it is effective to set the added amount of the development inhibitor releasing compounds to be 0.5 mol or less per mol of the silver halide, specifically preferably 0.1 mol or less, and more preferably 0-0.05 mol.

Further, in silver halide emulsions, it is effective to reduce the silver iodide content with conventional silver iodobromide. Generally, the average silver iodide content in silver halide emulsions used for the conventional silver halide color photographic sensitive material for image capture is 8 mol % or more, however, the conditions defined in this invention may be effectively achieved by effecting a content of 1-7 mol %, and preferably 2-6 mol %.

The development processing of the silver halide color photographic sensitive material for image capture in this invention is conducted using the processing methods and the processing solutions for color negative films described in Annual of the British Journal of Photography (1988), pp. 196-198.

To read the image information obtained after development processing, a scanner is usually employed. A scanner in this invention means a device for optically scanning a photographic sensitive material after development processing, and then, converting the transmitted optical density to the image data. During scanning, optical section of a scanner is usually transferred in a direction different from that of the photographic sensitive material, so as to scan at least the necessary region of the photographic sensitive material, and is the recommended method. However, it may be possible that only optical section of a scanner is transferred while the photographic sensitive material is fixed, or optical section of a scanner is fixed and the photographic sensitive material is conveyed. Further, combinations of these means are acceptable.

A light source to read image information may be employed basically without limitation, such as a tungsten lamp, a fluorescent lamp, a light-emitted diode or laser light. A tungsten lamp is preferable from the viewpoint of cost, and laser light (being a coherent light source) is preferable from the viewpoint of stability, intensity and reduced beam scattering. Reading methods are also not specifically limited, but it is preferable to enable reading with transmitted light from the viewpoint of sharpness.

In this invention, images obtained on photographic sensitive material are read using a scanner and converted to digital information, and thus, can be digitally recorded on other recording medium.

In the color image forming method of this invention, the digital image data conversion of the silver halide color photographic sensitive material is characterized by conversion to signals in proportion to image luminance with nonlinear conversion, after the outputted signals, and in proportion to the transmitted light volume, are subjected to shading correction, pixel sensitivity correction and dark current correction.

Shading correction and pixel sensitivity correction of this invention mean correction of fluctuation in sensitivity of bits of a photo acceptance unit and the correction of fluctuation due to distortion such as illumination light distribution and reduction of marginal light amount of the lens. Further, dark current correction means to correct the current flowing through a photo acceptance unit even when light is not radiated.

The color image forming method of this invention is found to be extremely effective to enhance quality of the obtained images by the correction of digital image data conversion as defined in this invention, and the following conversion to signals in proportion to image luminance via nonlinear conversion. Contrarily, with the digital image data conversion method as a prior procedure of conducting the nonlinear conversion process in advance, followed by shading correction, pixel sensitivity correction and dark current correction, to convert to signals in proportion to image luminance, the desired objective effects of this invention cannot be achieved.

As printers usable in this invention, listed are color positive image forming type printers such as an ink-jet, dye sublimation type thermal transfer, wax type thermal transfer, color electrography, and instant photographic printers.

Next, the silver halide color photographic light sensitive material for image capture of the present invention will be described.

The silver halide emulsions usable in the silver halide color photographic material for image capture of this invention are described in selected sections of Research Disclosure (hereinafter, shown as RD), No. 308,119.

The described locations are listed below. Each of the numeric values indicates a page or a section.

| | [RD 308,119] | |
|---|---|---|
| [Item] | page | Section |
| Iodine content | 993 | I-A |
| Production methods | 993 | I-A and |
| | 994 | I-E |
| Crystal habit | | |
| Normal crystal | 993 | I-A |
| Twin crystal | 993 | I-A |
| Epitaxial | 993 | I-A |
| Halogen composition | | |
| Uniform | 993 | I-B |
| Nonuniform | 993 | I-B |
| Halogen conversion | 994 | I-C |
| Halogen substitution | 994 | I-C |
| Metal containing | 994 | I-D |
| Monodispersion | 995 | I-F |
| Solvent addition | 995 | I-F |
| Latent image forming position | | |
| Surface | 995 | I-G |
| Interior | 995 | I-G |
| Applied photographic sensitive material | | |
| Negative | 995 | I-H |
| Positive (containing internal fogged particles) | 995 | I-H |
| Emulsion mixing | 995 | I-J |
| Desalting | 995 | II-A |

In this invention, silver halide emulsions conducted for physical ripening, chemical ripening and spectral sensitization are employed. The additives used in these processes are described in RD Nos. 17,643, 18,716 and 308,119. The described positions are listed below.

| | [RD No. 308,119] | | [RD No. 17,643] | [RD No. 18,716] |
|---|---|---|---|---|
| [Items] | Page | Section | Page | Page |
| Chemical sensitizing agents | 996 | III-A | 23 | 648 |
| Spectral sensitizing agents | 996 | IV-A-A, | 23-24 | 648-649 |
| | | -A-B, -A-C, | | |
| | | -A-D, -A-H, | | |
| | | -A-I, -A-J, | | |
| Super spectral sensitizing agents | 996 | IV-A-E, | 23-24 | 648-649 |
| | | IV-A-J | | |
| Fogging inhibiting agents | 998 | VI | 24-25 | 649 |
| Stabilizing agents | 998 | VI | 24-25 | 649 |

Additives for photography well known in the art usable for the silver halide color photographic light sensitive material of this invention are also described in the foregoing RD. The relevant described locations are listed below.

| | [RD No. 308,119] | | [RD No. 17,643] | [RD No. 18,716] |
|---|---|---|---|---|
| [Items] | Page | Section | Page | Page |
| Anti-color contamination agents | 1,002 | VII-I | 25 | 650 |
| Dye image stabilizing agents | 1,001 | VII-J | 25 | |
| Whitening agents | 998 | V | 24 | |
| UV absorbing agents | 1,003 | VIII-I | 25-26 | |
| | | VIII-C | | |
| Light absorbing agents | 1,003 | VIII | 25-26 | |
| Light scattering agents | 1,003 | VIII | | |
| Filter dyes | 1,003 | VIII | 25-26 | |
| Binders | 1,003 | IX | 26 | 651 |
| Antistatic agents | 1,006 | XIII | 27 | 650 |
| Hardening agents | 1,004 | X | 26 | 651 |
| Plastisizing materials | 1,006 | XII | 27 | 650 |
| Lubricating agents | 1,006 | XII | 27 | 650 |
| Surface active agents · coating aids | 1,005 | XI | 26-27 | 650 |
| Matting agents | 1,007 | XVI | | |
| Developing agent (contained in the silver halide color | 1,001 | XX-B | | |
| photographic sensitive material) | | | | |

In the photographic sensitive layers of this invention, various couplers may be employed, and specific examples are described in the foregoing RD. The relevant described locations are listed below.

| | [RD No. 308,119] | | [RD No. 17,643] |
|---|---|---|---|
| [Items] | Page | Section | Section |

| | | | |
|---|---|---|---|
| Yellow couplers | 1,001 | VII-D | VII C-G |
| Magenta couplers | 1,001 | VII-D | VII C-G |
| Cyan couplers | 1,001 | VII-D | VII C-G |
| Colored couplers | 1,002 | VII-G | VII G |
| DIR couplers | 1,001 | VII-F | VII F |
| BAR couplers | 1,002 | VII-F | |
| Other usable residual | 1,001 | VII-F | |
| group releasing couplers | | | |
| Alkali soluble couplers | 1,001 | VII-E | |

The foregoing additives may be added using a dispersion method described in RD No. 308,119, Sec. XIV.

To the silver halide color photographic sensitive material of this invention, provided may be auxiliary layers such as filter layers and intermediate layers, described in the foregoing RD No. 308,119, Sec. VII-K.

The silver halide color photographic sensitive material of this invention may take various layer configurations such as conventional layer order, inverse layer order and unit structures, described in the foregoing RD No. 308,119, Sec. VII-K.

To conduct development processing of the silver halide color photographic sensitive material of this invention, allowable are developing agents in the public domain described in, for example, “The Theory of the Photographic Process” 4^{th} edition, edited by T. H. James, on pp. 291-334, and “Journal of the American Chemical Society”, vol. 73, No. 3, pg. 100 (1951). Development processing is conducted with common methods described in the foregoing RD No. 17,643, on pp. 28-29, RD No. 18,716, on pg. 615 and RD No. 308,119, in Sec. XIX.

### EXAMPLES

The present invention will now be described below with examples, but the embodiments of this invention are not limited to these examples.

### Example 1

### Preparation of Silver Halide Color Photographic Light Sensitive Material

Preparation of Sample 101

Onto a 125 μm thick cellulose triacetate film substrate provided with a subbing layer, the following coating compositions were applied to obtain Sample 101 as a multi-layered silver halide color photographic sensitive material for image capture.

In all descriptions below, the applied amount of each additive agent to the silver halide color photographic material is indicated by grams per m² unless otherwise specified. Further, the amount of a silver halide and colloidal silver is indicated in terms of metallic silver, and the amount of spectral sensitizing dye is indicated by mol per mol of silver halide.

| The 1^{st} Layer: Antihalation Layer | |
|---|---|
| Black colloidal silver | 0.18 |
| UV absorbing agent (UV-1) | 0.3 |
| Colored coupler (CM-1) | 0.08 |
| Colored coupler (CC-1) | 0.05 |
| High boiling point organic solvent (OIL-1) | 0.16 |
| High boiling point organic solvent (OIL-2) | 0.5 |
| Gelatin | 1.5 |
| The 2^{nd} Layer: Intermediate layer | |
| Colored coupler (CC-1) | 0.035 |
| High boiling point organic solvent (OIL-2) | 0.08 |
| Gelatin | 0.7 |
| The 3^{rd} Layer: Low Sensitivity | |
| Red Sensitive Layer | |
| Silver iodobromide emulsion a | 0.30 |
| Silver iodobromide emulsion b | 0.06 |
| Spectral sensitizing dye (SD-1) | 1.10 × 10⁻⁵ |
| Spectral sensitizing dye (SD-2) | 5.40 × 10⁻⁵ |
| Spectral sensitizing dye (SD-3) | 1.25 × 10⁻⁴ |
| Cyan coupler (C-1) | 0.30 |
| Colored coupler (CC-1) | 0.054 |
| DIR compound (DI-1) | 0.02 |
| High boiling point organic solvent (OIL-2) | 0.3 |
| Compound (AS-2) | 0.001 |
| Gelatin | 1.5 |
| The 4^{th} Layer: Intermediate Sensitivity | |
| Red Sensitive Layer | |
| Silver iodobromide emulsion b | 0.37 |
| SD-1 | 1.50 × 10⁻⁵ |
| SD-2 | 7.00 × 10⁻⁵ |
| SD-3 | 1.65 × 10⁻⁴ |
| C-1 | 0.23 |
| CC-1 | 0.038 |
| DI-1 | 0.01 |
| OIL-2 | 0.27 |
| AS-2 | 0.001 |
| Gelatin | 1.5 |
| The 5^{th} Layer: High Sensitivity | |
| Red Sensitive Layer | |
| Silver iodobromide emulsion a | 0.04 |
| Silver iodobromide emulsion b | 0.18 |
| Silver iodobromide emulsion c | 0.50 |
| SD-1 | 1.30 × 10⁻⁵ |
| SD-2 | 6.00 × 10⁻⁵ |
| SD-3 | 1.40 × 10⁻⁴ |
| C-1 | 0.15 |
| CC-1 | 0.03 |
| DI-1 | 0.004 |
| OIL-2 | 0.19 |
| AS-2 | 0.002 |
| Gelatin | 1.2 |
| The 6^{th} Layer: Intermediate layer | |
| OIL-1 | 0.08 |
| AS-1 | 0.08 |
| Gelatin | 0.9 |
| The 7^{th} Layer: Low Sensitivity Green | |
| Sensitive Layer | |
| Silver iodobromide emulsion a | 0.22 |
| Silver iodobromide emulsion d | 0.09 |
| SD-4 | 1.50 × 10⁻⁴ |
| SD-5 | 3.75 × 10⁻⁵ |
| M-1 | 0.35 |
| CM-1 | 0.12 |
| OIL-1 | 0.49 |
| DI-2 | 0.017 |
| AS-2 | 0.0015 |
| Gelatin | 2.2 |
| The 8^{th} Layer: Intermediate Sensitivity | |
| Green Sensitive Layer | |
| Silver iodobromide emulsion d | 0.46 |
| SD-5 | 2.10 × 10⁻⁵ |
| SD-6 | 1.61 × 10⁻⁴ |
| SD-7 | 2.40 × 10⁻⁵ |
| M-1 | 0.1 |
| CM-1 | 0.05 |
| OIL-1 | 0.15 |
| AS-2 | 0.001 |
| Gelatin | 1.6 |
| The 9^{th} Layer: High Sensitivity | |
| Green Sensitive Layer | |
| Silver iodobromide emulsion a | 0.03 |
| Silver iodobromide emulsion e | 0.47 |
| SD-5 | 1.90 × 10⁻⁵ |
| SD-6 | 1.43 × 10⁻⁴ |
| SD-7 | 2.10 × 10⁻⁵ |
| M-1 | 0.033 |
| M-2 | 0.023 |
| CM-1 | 0.023 |
| DI-1 | 0.009 |
| DI-2 | 0.0009 |
| OIL-1 | 0.08 |
| AS-2 | 0.002 |
| Gelatin | 1.2 |
| The 10^{th} Layer: Yellow Filter Layer | |
| Yellow Colloidal Silver | 0.08 |
| OIL-1 | 0.06 |
| AS-1 | 0.8 |
| Gelatin | 0.9 |
| The 11^{th} Layer: Low Sensitivity | |
| Blue Sensitive Layer | |
| Silver iodobromide emulsion a | 0.18 |
| Silver iodobromide emulsion f | 0.14 |
| Silver iodobromide emulsion g | 0.08 |
| SD-8 | 1.15 × 10⁻⁴ |
| SD-9 | 5.60 × 10⁻⁵ |
| SD-10 | 2.56 × 10⁻⁵ |
| Y-1 | 1.0 |
| OIL-1 | 0.40 |
| AS-2 | 0.002 |
| FS-1 | 0.08 |
| Gelatin | 3.0 |
| The 12^{th} Layer: High Sensitivity | |
| Yellow Sensitive Layer | |
| Silver iodobromide emulsion g | 0.30 |
| Silver iodobromide emulsion h | 0.30 |
| SD-8 | 7.12 × 10⁻⁵ |
| SD-10 | 2.39 × 10⁻⁵ |
| Y-1 | 0.1 |
| OIL-1 | 0.04 |
| AS-2 | 0.002 |
| FS-1 | 0.01 |
| Gelatin | 1.10 |
| The 13^{th} Layer: 1^{st} Protective Layer | |
| Silver iodobromide emulsion i | 0.3 |
| UV-1 | 0.11 |
| UV-2 | 0.53 |
| Gelatin | 0.9 |
| The 14^{th} Layer: 2^{nd} Protective Layer | |
| PM-1 | 0.15 |
| PM-2 | 0.04 |
| WAX-1 | 0.02 |
| Gelatin | 0.55 |

Other than these components described above, appropriately applied to each layer were compounds SU-1 and SU-2, viscosity adjusting agent V-1, hardening agents H-1 and H-2, stabilizing agents ST-1 and ST-2, antifogging agents AF-1, AF-2 and AF-3, dyes AI-1, AI-2 and AI-3, and antiseptic agent D-1.

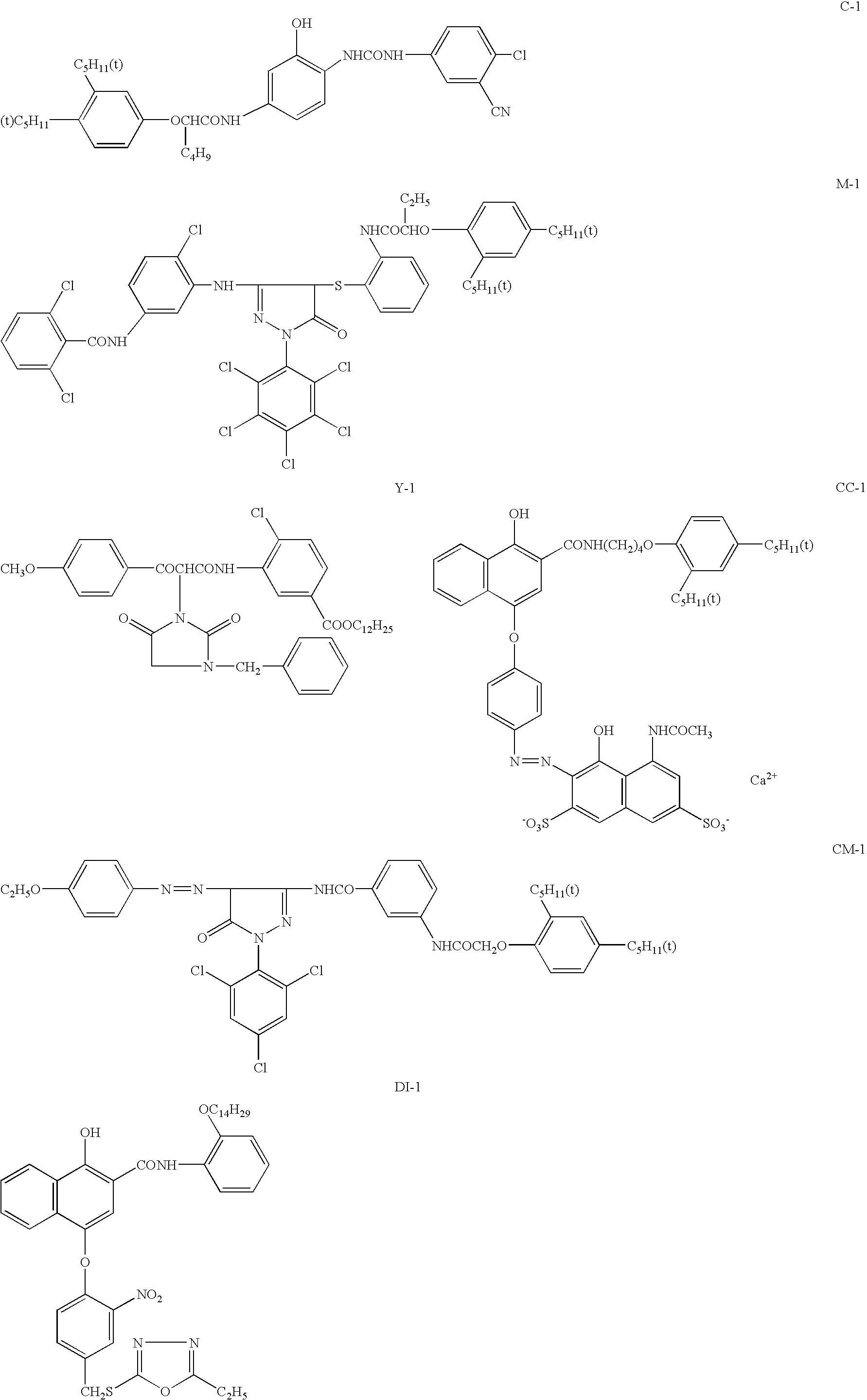

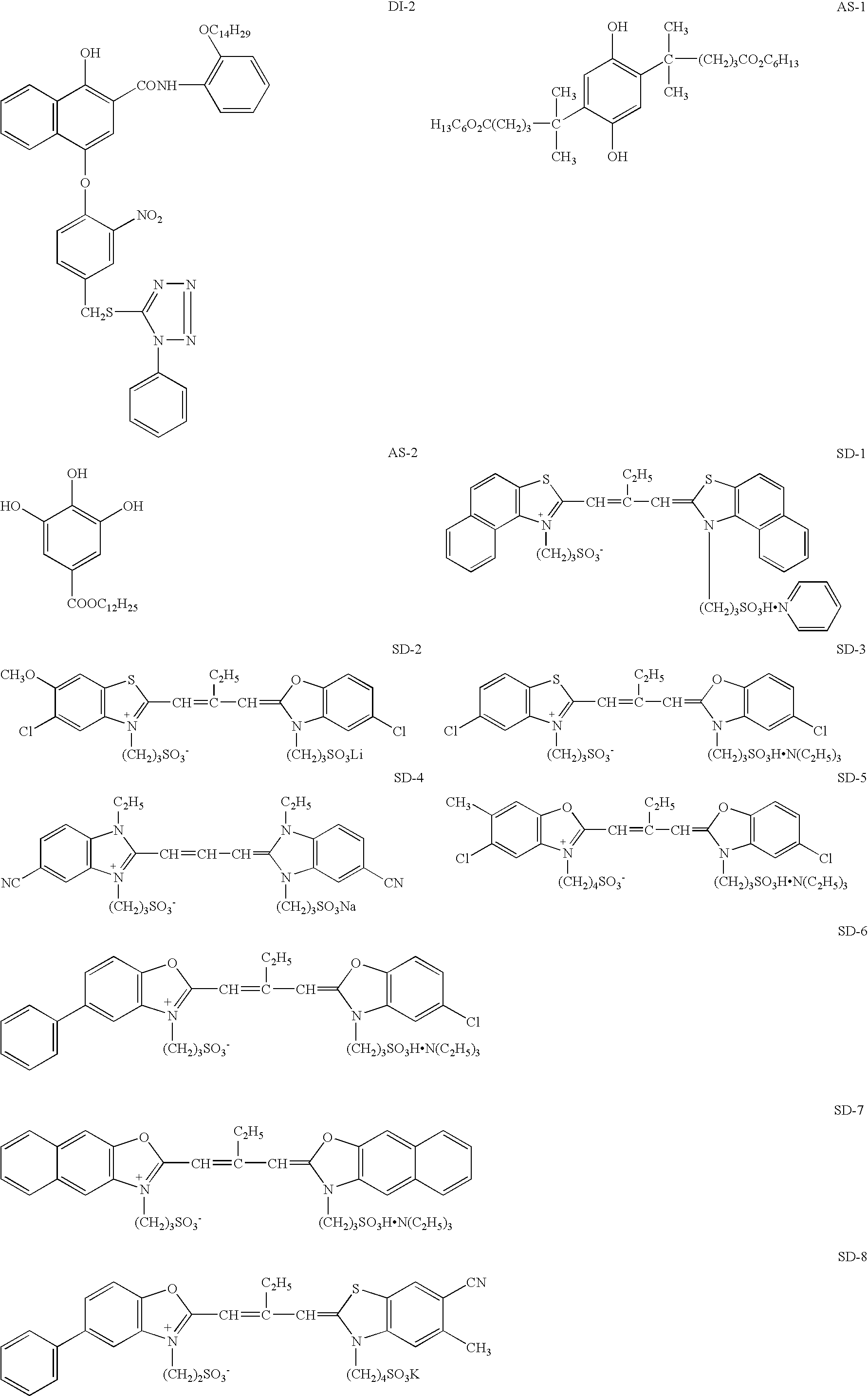

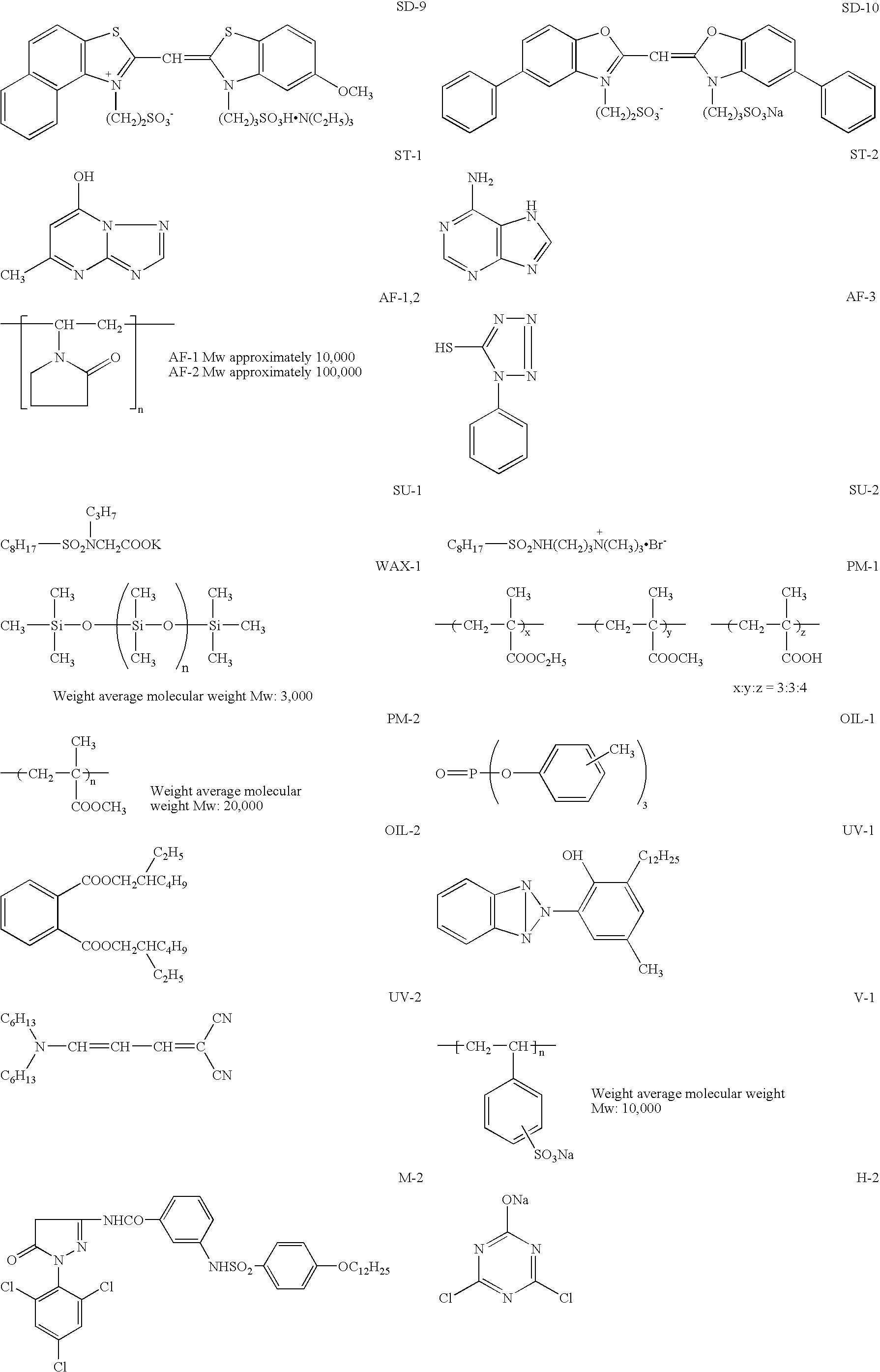

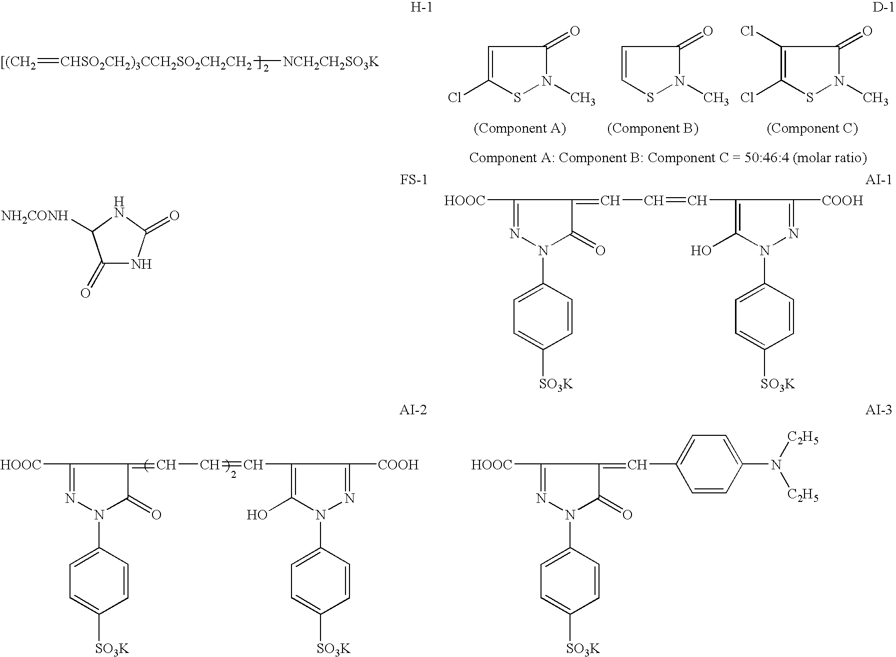

The list of emulsions employed in the foregoing Sample 101 is shown in the following table 3. The average particle diamiters are shown in term of cubic.

TABLE 3

| | Average | Average | | |
|---|---|---|---|---|
| | AgI | particle | | Diameter/ |
| | content | diameter | Crystal | Thickness |
| Emulsion | (mol %) | (μm) | habit | ratio |
| Silver | 2.0 | 0.27 | Normal | 1.0 |
| iodobromide | | | crystal | |
| emulsion a | | | | |
| Silver | 3.6 | 0.48 | Twin | 3.7 |
| iodobromide | | | crystal | |
| emulsion b | | | | |
| Silver | 7.6 | 0.68 | Twin | 6.5 |
| iodobromide | | | crystal | |
| emulsion c | | | | |
| Silver | 4.7 | 0.45 | Twin | 3.7 |
| iodobromide | | | crystal | |
| emulsion d | | | | |
| Silver | 5.6 | 0.70 | Twin | 7.0 |
| iodobromide | | | crystal | |
| emulsion e | | | | |
| Silver | 8.0 | 0.38 | Normal | 1.0 |
| iodobromide | | | crystal | |
| emulsion f | | | | |
| Silver | 8.0 | 0.65 | Twin | 1.5 |
| iodobromide | | | crystal | |
| emulsion g | | | | |
| Silver | 8.0 | 0.80 | Twin | 2.0 |
| iodobromide | | | crystal | |
| emulsion h | | | | |
| Silver | 2.0 | 0.03 | Normal | 1.0 |
| iodobromide | | | crystal | |
| emulsion i | | | | |

Silver iodobromide emulsions b, e, g and h contained iridium in the amount of 1×10⁻⁷-1×10⁻⁶ mol/1 mol Ag.

Each of the emulsions other than foregoing silver iodobromide emulsion i was subjected to chemical sensitization so that the relationship of fogging vs. sensitivity was optimized, by applying sodium thiosulfate, chloroauric acid, and potassium thiocyanate, after addition of the foregoing spectral sensitizing dyes.

Regarding Sample 101, γR₁, γR₂, γG₁, γG₂, γB₁ and γB₂ of each of the light-sensitive layers were 0.61-0.68, after being subjected to wedge exposure and color development processing with the methods described later.

Preparation of Samples 102-113

Samples 102-113 were prepared in the same manner as Sample 101, except that following gradation correction actions 1-5 were provided in the combinations described in Table 4.

Gradation Correction Action 1

The following correction was applied to above Sample 101.

Red light-sensitive layer unit: Each of the average particle diameters of Silver iodobromide emulsions a and b used in the 3^{rd} layer and the 4^{th} layer was changed to 0.36 μm and 0.65 μm respectively.

Green light-sensitive layer unit: Each of the average particle diameters of Silver iodobromide emulsions a and d used in the 7^{th} layer and the 8^{th} layer was changed to 0.36 μm and 0.60 μm respectively.

Blue light-sensitive layer unit: Each of the average particle diameters of Silver iodobromide emulsions a, f and g used in the 11^{th} layer was changed to 0.36 μm, 0.50 μm and 0.85 μm respectively.

Gradation Correction Action 2

In the layer configuration of above Sample 101, along with a procedure to eliminate all of the colored couplers of CC-1 and CM-1 used in the 1^{st}-5^{th} layers and the 7^{th}-9^{th} layers, fogging density of the red light-sensitive layers was reduced by an appropriate increase of the applied amounts of DIR compound (DI-1).

Gradation Correction Action 3

The following correction was applied to above Sample 101.

Red light-sensitive layer unit: Each of the silver coverage of the 3^{rd} and 4^{th} layer was changed to 0.47 g/m² and 0.48 g/m² respectively.

Green light-sensitive layer unit: Each of the silver coverage of the 7^{th} and 8^{th} layer was changed to 0.40 g/m² and 0.50 g/m² respectively.

Blue light-sensitive layer unit: Each of the silver coverage of the 11^{th} layer was changed to 0.52 g/m².

Gradation Correction Action 4

The following correction was applied to above Sample 101.

Cyan coupler C-1 used in the 3^{rd}-5^{th} layers of the red light-sensitive layer unit was changed to each of the following cyan couplers.

Action 4-A: Cyan coupler C-1 was changed to equimolal cyan coupler C-2.

Action 4-B: Cyan coupler C-1 was changed to equimolal cyan coupler C-3.

Action 4-C: Cyan coupler C-1 was changed to equimolal cyan coupler C-4, along with a change of high boiling point organic solvent (OIL-2) to the same amount of high boiling point organic solvent (OIL-1).

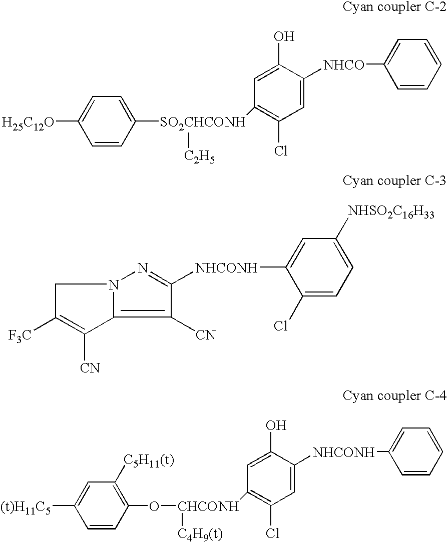

Gradation Correction Action 5

In the layer configuration of above Sample 101, all of development inhibitor releasing compounds DI-1 and DI-2 used in the 3^{rd}-5^{th}, 7^{th} and 9^{th} layers were eliminated.

TABLE 4

| Sample | | | Action | Action | Action | |
|---|---|---|---|---|---|---|
| No. | Action 1 | Action 2 | 3 | 4 | 5 | Remarks |
| 101 | — | — | — | — | — | Comp. |
| 102 | Applied | — | — | — | — | Comp. |
| 103 | Applied | Applied | — | — | — | Inv. |
| 104 | Applied | — | Applied | — | — | Inv. |
| 105 | Applied | Applied | Applied | — | — | Inv. |
| 106 | Applied | — | — | 4-A | — | Inv. |
| 107 | Applied | — | — | 4-B | — | Inv. |
| 108 | Applied | — | — | 4-C | — | Inv. |
| 109 | Applied | Applied | Applied | 4-A | — | Inv. |
| 110 | Applied | — | — | — | Applied | Inv. |
| 111 | Applied | Applied | Applied | — | Applied | Inv. |
| 112 | Applied | Applied | Applied | 4-A | Applied | Inv. |
| 113 | Applied | Applied | Applied | 4-C | Applied | Inv. |

Note:
Comp.: Comparative sample
Inv.: This invention

Measurement of Characteristic Values of Each Sample

Exposure and Development

White Light Exposure

Each Sample prepared as above was subjected to wedge exposure at 1/200 sec. using a light source at a color temperature of 5,400 K, after which the standard development processing described below was conducted to prepare each color-developed sample.

Processing Conditions

| | Processing | Processing | Replenishment |
|---|---|---|---|
| Process | time | temperature | rate* |
| Color | 3 min. 15 sec. | 38 ± 0.3° C. | 780 ml |
| Development | | | |
| Bleaching | 45 sec. | 38 ± 2.0° C. | 150 ml |
| Fixing | 1 min. 30 sec. | 38 ± 2.0° C. | 830 ml |
| Stabilizing | 1 min. | 38 ± 5.0° C. | 830 ml |
| Drying | 1 min. | 55 ± 5.0° C. | |

*Replenishment rates were volume per m² of the samples.

Components of Each Processing Solution

The color development solution, bleaching solution, fixing solution, stabilizing solution and the replenishment solution of these are shown below.

Color Development Solution

| | | |
|---|---|---|
| Water | 800 | ml |
| Potassium carbonate | 30 | g |
| Sodium hydrogen carbonate | 2.5 | g |
| Potassium sulfite | 3.0 | g |
| Sodium bromide | 1.3 | g |
| Potassium iodide | 1.2 | mg |
| Hydroxylamine sulfate | 2.5 | g |
| Sodium Chloride | 0.6 | g |
| 4-amino-3-methyl-N-ethyl-N- | 4.5 | g |
| (β-hydroxyethyl) aniline sulfate | | |
| Diethylenetriaminepentaacetic acid | 3.0 | g |
| Potassium hydroxide | 1.2 | g |

The total volume was brought to 1 L by addition of water, after which the pH was adjusted to 10.06 using potassium hydroxide or 20% sulfuric acid.

Color Development Replenishment Solution

| | | |
|---|---|---|
| Water | 800 | ml |
| Potassium carbonate | 35 | g |
| Sodium hydrogen carbonate | 3 | g |
| Potassium sulfite | 5 | g |
| Sodium bromide | 0.4 | g |
| Hydroxylamine sulfate | 3.1 | g |
| 4-amino-3-methyl-N-ethyl-N- | 6.3 | g |
| (β-hydroxyethyl) aniline sulfate | | |
| Potassium hydroxide | 2 | g |
| Diethylenetriaminetetraacetic acid | 3.0 | g |

The total volume was brought to 1 L by addition of water, after which the pH was adjusted to 10.18 using potassium hydroxide or 20% sulfuric acid.

Bleaching Solution

| | | |
|---|---|---|
| Water | 700 | ml |
| 1,3-diaminopropanetetraacetic acid | 125 | g |
| iron (III) ammonium | | |
| Ethylenediaminetetraacetic acid | 2 | g |
| Sodium nitrate | 40 | g |
| Ammonium bromide | 150 | g |
| Glacial acetic acid | 40 | g |

The total volume was brought to 1 L by addition of water, after which the pH was adjusted to 4.4 using aqueous ammonia or glacial acetic acid.

Bleaching Replenishment Solution

| | | |
|---|---|---|
| Water | 700 | ml |
| 1,3-diaminopropanetetraacetic acid | 175 | g |
| iron (III) | | |
| Ethylenediaminetetraacetic acid | 2 | g |
| Sodium nitrate | 50 | g |
| Ammonium bromide | 200 | g |
| Glacial acetic acid | 56 | g |

The pH was adjusted to 4.4 using aqueous ammonia or glacial acetic acid, after which the total volume was brought to 1 L by addition of water.

Fixing Solution

| | | |
|---|---|---|
| Water | 800 | ml |
| Ammonium thiocyanate | 120 | g |
| Ammonium thiosulfate | 150 | g |
| Sodium sulfite | 15 | g |
| Ethylenediaminetetraacetic acid | 2 | g |

The pH was adjusted to 6.2 using aqueous ammonia or glacial acetic acid, after which the total volume was brought to 1 L by addition of water.

Fixing Replenishment Solution

| | | |
|---|---|---|
| Water | 800 | ml |
| Ammonium thiocyanate | 150 | g |
| Ammonium thiosulfate | 180 | g |
| Sodium sulfite | 20 | g |
| Ethylenediaminetetraacetic acid | 2 | g |

The pH was adjusted to 6.5 using aqueous ammonia or glacial acetic acid, after which the total volume was brought to 1 L by addition of water.

Stabilizing Solution and Stabilizing Replenishment Solution

| | | |
|---|---|---|
| Water | 900 | ml |
| Para-octylphenyl polyoxyethylene | 2.0 | g |
| ether (n = 10) | | |
| dimethylol urea | 0.5 | g |
| Hexamethylenetetramine | 0.2 | g |
| 1,2-benzoisothiazoline-3-one | 0.1 | g |
| siloxane (L-77, produced by UCC.) | 0.1 | g |
| Aqueous ammonia | 0.5 | ml |

The total volume was brought to 1 L by addition of water, after which the pH was adjusted to a value of 8.5 using aqueous ammonia or a 50% aqueous solution of sulfuric acid.

Color Separation Exposure

Each of the samples was wedge-exposed at 1/200 sec. using a 5,400 K color temperature light source through a W-26 filter for red light exposure, a No. 99 filter for green light exposure and a No. 98 filter for blue light exposure, employing Wratten filters produced by Eastman Kodak Company, after which the foregoing standard color development processing was conducted to prepare the color developed samples of each color separation exposure.

Preparation of Characteristic Curves

Density of each of the samples prepared above, which were color-developed after exposure of white light and each color separated light was measured with red light, green light and blue light using a transmission densitometer, model 310T manufactured by X-Rite Inc. The characteristic curves consisting of the exposure amount (Log E) in the horizontal axis and the density (D) in the vertical axis were obtained. Measurement of each γ value

Determined were Gradient A (γR₁, γG₁ and γB₁) of straight lines connecting a point having a density of 0.03 above the minimum transmission density and a point having a density of 1.50 above the minimum transmission density, Gradient B (γR₂, γG₂ and γB₂) of straight lines connecting a point having a density of 1.50 above the minimum transmission density and a point having a density of 2.50 above the minimum transmission density, differences of each γ of (γR₁, γG₁ and γB₁) and (γR₂, γG₂ and γB₂) respectively, and Gradient C (γR₃, γG₃ and γB₃) of straight lines connecting a point having a density of 0.70 above the minimum transmission density and a point having a density of 2.00 above the minimum transmission density, all of which were obtained from each of the samples employing white light exposure. The results are shown in Table 5.

The details of *1-*6 described in Table 5 are as follows:

TABLE 5

| Sample | Gradient A | | | Gradient B | | | Gradient difference | | | | | | Gradient C | | | |
|---|---|---|---|---|---|---|---|---|---|---|---|---|---|---|---|---|
| No. | γR₁ | γG₁ | γB₁ | γR₂ | γG₂ | γB₂ | *1 | *2 | *3 | *4 | *5 | *6 | γR₃ | γG₃ | γB₃ | Remarks |
| 101 | 0.58 | 0.64 | 0.73 | 0.59 | 0.67 | 0.77 | 0.06 | 0.09 | 0.15 | 0.08 | 0.10 | 0.18 | 0.59 | 0.66 | 0.75 | Comp. |
| 102 | 0.83 | 0.89 | 0.91 | 0.96 | 1.02 | 1.05 | 0.06 | 0.02 | 0.08 | 0.06 | 0.03 | 0.09 | 0.87 | 0.94 | 0.96 | Camp. |
| 103 | 0.83 | 0.89 | 0.91 | 0.96 | 1.02 | 1.05 | 0.06 | 0.02 | 0.08 | 0.06 | 0.03 | 0.09 | 0.87 | 0.94 | 0.96 | Inv. |
| 104 | 0.89 | 0.94 | 0.99 | 0.98 | 1.06 | 1.07 | 0.05 | 0.05 | 0.10 | 0.08 | 0.01 | 0.09 | 0.94 | 1.00 | 1.03 | Inv. |
| 105 | 0.89 | 0.94 | 0.99 | 0.98 | 1.06 | 1.07 | 0.05 | 0.05 | 0.10 | 0.08 | 0.01 | 0.09 | 0.94 | 1.00 | 1.03 | Inv. |
| 106 | 0.84 | 0.89 | 0.91 | 0.98 | 1.02 | 1.05 | 0.05 | 0.02 | 0.07 | 0.04 | 0.03 | 0.07 | 0.92 | 0.94 | 0.96 | Inv. |
| 107 | 0.86 | 0.89 | 0.91 | 0.99 | 1.02 | 1.05 | 0.03 | 0.02 | 0.05 | 0.03 | 0.03 | 0.06 | 0.92 | 0.94 | 0.96 | Inv. |
| 108 | 0.85 | 0.89 | 0.91 | 0.98 | 1.02 | 1.05 | 0.04 | 0.02 | 0.06 | 0.04 | 0.03 | 0.07 | 0.91 | 0.94 | 0.96 | Inv. |
| 109 | 0.84 | 0.89 | 0.91 | 0.98 | 1.02 | 1.05 | 0.05 | 0.02 | 0.07 | 0.04 | 0.03 | 0.07 | 0.92 | 0.94 | 0.96 | Inv. |
| 110 | 0.89 | 0.91 | 0.92 | 0.99 | 1.04 | 1.06 | 0.02 | 0.01 | 0.03 | 0.05 | 0.02 | 0.07 | 0.91 | 0.95 | 0.98 | Inv. |
| 111 | 0.93 | 0.95 | 0.96 | 1.03 | 1.06 | 1.07 | 0.02 | 0.01 | 0.03 | 0.03 | 0.01 | 0.04 | 0.98 | 1.01 | 1.03 | Inv. |
| 112 | 0.95 | 0.95 | 0.96 | 1.06 | 1.06 | 1.07 | 0.00 | 0.01 | 0.01 | 0.00 | 0.01 | 0.01 | 1.00 | 1.01 | 1.03 | Inv. |
| 113 | 0.95 | 0.95 | 0.96 | 1.05 | 1.06 | 1.07 | 0.00 | 0.01 | 0.01 | 0.01 | 0.01 | 0.02 | 1.00 | 1.01 | 1.03 | Inv. |

Note:
Comp.: Comparative sample
Inv.: This invention
*1: |γR₁-γG₁|
*2: |γG₁-γB₁|
*3: |γR₁-γB₁|
*4: |γR₂-γG₂|
*5: |γG₂-γB₂|
*6: |γR₂-γB₂|

Measurement of Minimum Transmission Density

Density of each white light exposed sample in the unexposed region was referred to as the minimum transmission density of the sample, and the obtained minimum transmission density values of each sample are shown in Table 6.

TABLE 6

| | Minimum | | | |
|---|---|---|---|---|
| | transmission | | | |
| Sample | density | | | |
| No. | R | G | B | Remarks |
| 101 | 0.22 | 0.46 | 0.65 | Comp. |
| 102 | 0.22 | 0.47 | 0.67 | Comp. |
| 103 | 0.10 | 0.11 | 0.12 | Inv. |
| 104 | 0.23 | 0.48 | 0.67 | Inv. |
| 105 | 0.11 | 0.12 | 0.13 | Inv. |
| 106 | 0.23 | 0.47 | 0.67 | Inv. |
| 107 | 0.22 | 0.47 | 0.67 | Inv. |
| 108 | 0.23 | 0.47 | 0.67 | Inv. |
| 109 | 0.12 | 0.12 | 0.13 | Inv. |
| 110 | 0.25 | 0.50 | 0.68 | Inv. |
| 111 | 0.13 | 0.13 | 0.13 | Inv. |
| 112 | 0.13 | 0.13 | 0.13 | Inv. |
| 113 | 0.13 | 0.13 | 0.13 | Inv. |

Note:
Comp.: Comparative sample
Inv.: This invention

Measurement of Maximum Transmission Density

Density of each white light exposed sample in the maximum exposed region was referred to as the maximum transmission density of the sample, and the obtained maximum transmission density values are shown in Table 7.

TABLE 7

| | Maximum | | | |
|---|---|---|---|---|
| | transmission density | | | |
| Sample No. | R | G | B | Remarks |
| 101 | 2.26 | 2.59 | 3.02 | Comp. |
| 102 | 2.58 | 2.94 | 3.39 | Comp. |
| 103 | 2.46 | 2.58 | 2.84 | Inv. |
| 104 | 2.81 | 3.09 | 3.41 | Inv. |
| 105 | 2.69 | 2.73 | 2.87 | Inv. |
| 106 | 2.67 | 2.94 | 3.39 | Inv. |
| 107 | 2.70 | 2.94 | 3.39 | Inv. |
| 108 | 2.68 | 2.94 | 3.39 | Inv. |
| 109 | 2.89 | 2.93 | 3.01 | Inv. |
| 110 | 2.91 | 3.26 | 3.49 | Inv. |
| 111 | 2.96 | 3.09 | 3.12 | Inv. |
| 112 | 3.08 | 3.09 | 3.12 | Inv. |
| 113 | 3.07 | 3.09 | 3.12 | Inv. |

Note:
Comp.: Comparative sample
Inv.: This invention

Measurement of Spectral Absorption Maximum Value

The spectral absorption characteristics of the red light-sensitive layer unit of the 3^{rd}-the 5^{th} layers in each white light exposed sample were measured using a spectrophotometer (V-570 UV/Vis/NIR Spectrophotometer manufactured by JASCO Corp.), after which the maximum absorption wavelength (nm) of the colored cyan coupler was determined. The obtained results are shown in Table 8.

TABLE 8

| | | Maximum | |
|---|---|---|---|
| | | absorption | |
| | Cyan coupler | wavelength of red | |
| Sample | in 3^{rd}-5^{th} | light-sensitive | |
| No. | layers | layer unit (nm) | Remarks |
| 101 | C-1/CC-1 | 695 | Comp. |
| 102 | C-1/CC-1 | 695 | Comp. |
| 103 | C-1/CC-1 | 695 | Inv. |
| 104 | C-1/CC-1 | 695 | Inv. |
| 105 | C-1/CC-1 | 695 | Inv. |
| 106 | C-2/CC-1 | 635 | Inv. |
| 107 | C-3/CC-1 | 654 | Inv. |
| 108 | C-4/CC-1 | 660 | Inv. |
| 109 | C-2/CC-1 | 635 | Inv. |
| 110 | C-1/CC-1 | 695 | Inv. |
| 111 | C-1/CC-1 | 695 | Inv. |
| 112 | C-2/CC-1 | 635 | Inv. |
| 113 | C-4/CC-1 | 660 | Inv. |

Note:
Comp.: Comparative sample
Inv.: This invention

measurement of Color Separation γ/White Exposure γ

In the characteristic curves of the white light exposure samples and the color separation light exposure samples, the point having a density of 0.03 above the minimum density and the point having a density of a 1.5 Log E exposure range from that point were connected by a straight line, and then the gradient of the straight line was determined and defined as a gamma value (a γ value). The ratio of γ values of the white exposure samples (γWR, γWG and γWB) to γ values of each color separation exposure samples (γR, γG and γB) was determined, the obtained results of which are shown in Table 9.

TABLE 9

| | Color separation γ/White | | | |
|---|---|---|---|---|
| Sample | exposure γ | | | |
| AANo. | γR/γWR | γG/γWG | γB/γWB | Remarks |
| 101 | 1.31 | 1.17 | 1.22 | Comp. |
| 102 | 1.33 | 1.19 | 1.24 | Comp. |
| 103 | 1.33 | 1.14 | 1.18 | Inv. |
| 104 | 1.32 | 1.18 | 1.23 | Inv. |
| 105 | 1.32 | 1.13 | 1.16 | Inv. |
| 106 | 1.31 | 1.13 | 1.16 | Inv. |
| 107 | 1.30 | 1.14 | 1.15 | Inv. |
| 108 | 1.31 | 1.12 | 1.16 | Inv. |
| 109 | 1.32 | 1.13 | 1.17 | Inv. |
| 110 | 1.03 | 1.02 | 1.02 | Inv. |
| 111 | 1.02 | 1.02 | 1.03 | Inv. |
| 112 | 1.02 | 1.02 | 1.02 | Inv. |
| 113 | 1.02 | 1.02 | 1.02 | Inv. |

Note:
Comp.: Comparative sample
Inv.: This invention

Evaluation of Formed Images of Each Sample

Samples 101-113 prepared as above were slit and perforated for normal 135 standard negative film, and loaded into a common camera to capture images of people and a color charted board produced by GretagMacbeth. Image capture was conducted under three conditions: under exposure (U), normal exposure (N) and over exposure (O).

Each of the captured image samples was treated with the foregoing standard color development processing, and image information recorded onto the development processed samples was read using a film scanner, being specifically a DUO Scan manufactured by Agfa-Gevaert AG., providing image processing on a personal computer. After the enhancing process for image quality and color reproduction, the obtained image information was outputted onto glossy surface paper for an ink-jet, “Photolike QP”, produced by Konica Corp., using a PM-7000 printer manufactured by Seiko Epson Corp.

Evaluation of Image Reading Property

Image reading property using the above film scanner and image processability were evaluated based on the following criteria.

A: The gradation was an extremely high gradient, and color balance among colors was quite good, resulting in excellent performance in film scanner reading and image processing with a PC.

B: The gradation was extremely high, and color balance among colors was quite good, resulting in good performance in film scanner reading and image processing with a PC.

C: Slight difficulty was observed in film scanner reading and image processing with a PC, but readings remained within tolerances from a practical viewpoint.

D: The gradation was soft, and color balances among colors were different, resulting in extreme difficulty in film scanner reading and image processing with a PC.

Evaluation of Image Quality

The quality of each ink-jet print image prepared as above was evaluated by 10 experienced persons in image quality evaluation. Evaluation was conducted by visual observation based on the following 5 steps, and results are shown as average values.

5: The extremely satisfactory images were obtained in terms of sharpness, graininess and color reproduction, and also very high gradation reproduction and representation from under- to over-exposed regions.

4: Satisfactory images were obtained in terms of sharpness, graininess and color reproduction, and also acceptable high gradation reproduction and representation from under- to over-exposed regions.

3: Nearly satisfactory images were obtained in terms of sharpness, graininess and color reproduction, and also nearly acceptable high gradation reproduction and representation from under to over exposed regions.

2: Unsatisfactory images were obtained with due to problems of sharpness, graininess and color reproduction, and also due to somewhat high gradation reproduction and representation from under- to over-exposed regions.

1: Unsatisfactory images were obtained with due to problems of sharpness, graininess and color reproduction, and also with high gradation reproduction and representation from under- to over-exposed regions.

In this invention, ranks of 3-5 were evaluated as being a practicable level.

The results obtained above shown in Table 10.

TABLE 10

| | | | | | | Evaluation result | | |
|---|---|---|---|---|---|---|---|---|
| | | | | | | | Image | |
| Sample | | | | | | Image reading | quality | |
| No. | Action 1 | Action 2 | Action 3 | Action 4 | Action 5 | property | evaluation | Remarks |
| 101 | — | — | — | — | — | D | 1.7 | Comp. |
| 102 | Applied | — | — | — | — | C | 2.3 | Comp. |
| 103 | Applied | Applied | — | — | — | B | 3.4 | Inv. |
| 104 | Applied | — | Applied | — | — | B | 3.5 | Inv. |
| 105 | Applied | Applied | Applied | — | — | B | 4.0 | Inv. |
| 106 | Applied | — | — | 4-A | — | B | 3.6 | Inv. |
| 107 | Applied | — | — | 4-B | — | B | 3.3 | Inv. |
| 108 | Applied | — | — | 4-C | — | B | 3.8 | Inv. |
| 109 | Applied | Applied | Applied | 4-A | — | A | 4.5 | Inv. |
| 110 | Applied | — | — | — | Applied | B | 3.1 | Inv. |
| 111 | Applied | Applied | Applied | — | Applied | A | 4.2 | Inv. |
| 112 | Applied | Applied | Applied | 4-A | Applied | A | 4.7 | Inv. |
| 113 | Applied | Applied | Applied | 4-C | Applied | A | 4.9 | Inv. |

Note:
Comp.: Comparative sample
Inv.: This invention

As is apparent from Table 10, it was proven that the silver halide color photographic light sensitive material for image capture of the present invention having gradation characteristics defined by this invention, could be easily read via scanner, and could provide image information for easy digital conversion, and further, it was proven that the silver halide color photographic light sensitive material for image capture of the present invention exhibited superior sharpness, graininess and color reproduction of outputted images, having a good gradation reproduction and representation from under to over exposed regions, compared to the comparative samples.

Based on the present invention, it is possible to provide a silver halide color photographic light sensitive material for image capture which is superior in image reading capability using a general purpose scanner, after which the read image information is easily converted to digital data, resulting in high quality color prints, and further, to provide a method for forming color images by which excellent color images can be formed, resulting in sufficiently high performance of the silver halide color photographic light sensitive material for image capture.

What is claimed is:

1. A silver halide color photographic light sensitive material for image capture comprising a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 320 or more,
wherein the light sensitive material produces an image after being exposed and being subjected to a development processing, the image having characteristic curves of color images formed in the red light-sensitive layer unit, in the green light-sensitive layer unit or in the blue light-sensitive layer unit, the characteristic curves satisfying Requirement 1:
Requirement 1, each of γR₁, γR₂, γG₁, γG₂, γB₁ and γB₂ being from 0.8 to 1.3, and each of |γR₁−γG₁|, |γG₁−γB₁|, |γR₁−γB₁|, |γR₂−γG₂|, |γG₂−γB₂|, and |γR₂−γB₂| being 0.1 or less,
wherein each of γR₁, γG₁ and γB₁ and is a gradient of a straight line connecting a point having a density of 0.30 above the minimum transmission density and a point having a density of 1.50 above the minimum transmission density in the red, green and blue light-sensitive layer units respectively, and
each of γR₂, γG₂ and γB₂ is a gradient of a straight line connecting a point having a density of 1.50 above the minimum transmission density and a point having a density of 2.50 above the minimum transmission density in the red, green and blue light-sensitive layer units respectively.

2. The silver halide color photographic light sensitive material for image capture according to claim 1, wherein each of a minimum transmission density of red, green and blue light of the characteristic curves is independently 0.20 or less.

3. The silver halide color photographic light sensitive material for image capture according to claim 1, wherein each of the maximum transmission density of red, green and blue light of the characteristic curves is independently 2.80 to 3.80.

4. The silver halide color photographic light sensitive material for image capture according to claim 1, wherein a spectral absorption maximum of a colored dye formed from a coupling reaction of a cyan coupler contained in the red light-sensitive layer unit with an oxidized aromatic primary amine color developing agent is 630 to 670 nm.

5. The silver halide color photographic light sensitive material for image capture according to claim 1, wherein each of color separation exposure gradations of γR, γG and γB and white light exposure gradation of γWR, γWG and γWB satisfy Requirement 2:
Requirement 2, each of γR/γWR, γG/γWG and γB/γWB being from 1.0 to 1.05,
wherein each of γR, γG and γB indicates a gradient of a straight line connecting a point having a density of 0.30 above the minimum transmission density and that of 1.50 above the minimum transmission density in each of the red, green and blue light-sensitive layer units, each straight line of which is obtained by color separation exposure of red, green and blue respectively, and
each of γWR, γWG and γWB indicates a gradient of a straight line connecting a point having a density of 0.30 above the minimum transmission density and 1.50 above the minimum transmission density in each of the red light-sensitive layer unit, green light-sensitive layer unit and blue light-sensitive layer unit respectively, of which each straight line is obtained by white light exposure.

6. The silver halide color photographic light sensitive material for image capture according to claim 2, wherein each of the characteristic curves of color images formed in the red light-sensitive layer unit, in the green light-sensitive layer unit or in the blue light-sensitive layer unit, satisfying Requirement 3:
Requirement 3, each of γR3, γG3 and γB3 being from 0.8 to 1.3,
wherein each of γR₃, γG₃ and γB₃ is a gradient of a straight line connecting a point having a density of 0.70 above the minimum transmission density and a point having a density of 2.00 above the minimum transmission density in the red, green and blue light-sensitive layer units respectively.

7. The silver halide color photographic light sensitive material for image capture according to claim 3, wherein each of the characteristic curves of color images formed in the red light-sensitive layer unit, in the green light-sensitive layer unit or in the blue light-sensitive layer unit, the characteristic curves satisfying Requirement 3:
Requirement 3, each of γR3, γG3 and γB3 being from 0.8 to 1.3,
wherein each of γR₃, γG₃ and γB₃ is a gradient of a straight line connecting a point having a density of 0.70 above the minimum transmission density and a point having a density of 2.00 above the minimum transmission density in the red, green and blue light-sensitive layer units respectively.

8. The silver halide color photographic light sensitive material for image capture according to claim 4, wherein each of the characteristic curves of color images formed in the red light-sensitive layer unit, in the green light-sensitive layer unit or in the blue light-sensitive layer unit, the characteristic curves satisfying Requirement 3:
Requirement 3, each of γR3, γG3 and γB3 being from 0.8 to 1.3,
wherein each of γR₃, γG₃ and γB₃ is a gradient of a straight line connecting a point having a density of 0.70 above the minimum transmission density and a point having a density of 2.00 above the minimum transmission density in the red, green and blue light-sensitive layer units respectively.

9. The silver halide color photographic light sensitive material for image capture according to claim 5, wherein each of the characteristic curves of color images formed in the red light-sensitive layer unit, in the green light-sensitive layer unit or in the blue light-sensitive layer unit, the characteristic curves satisfying Requirement 3:
Requirement 3, each of γR3, γG3 and γB3 being from 0.8 to 1.3,
wherein each of γR₃, γG₃ and γB₃ is a gradient of a straight line connecting a point having a density of 0.70 above the minimum transmission density and a point having a density of 2.00 above the minimum transmission density in the red, green and blue light-sensitive layer units respectively.

10. A method for forming color images to obtain color prints from outputted digital images after the silver halide color photographic light sensitive material for image capture has been exposed and development processed, followed by digital image conversion,
wherein the light sensitive material produces an image after being exposed and being subjected to a development processing, the image having characteristic curves of color images formed in the red light-sensitive layer unit, in the green light-sensitive layer unit and in the blue light-sensitive layer unit, each light-sensitive layer unit having at least 2 layers of the same spectral sensitivity having a different light sensitivity, the characteristic curves satisfying Requirement 1, and
digital image data conversion is conducted using a method comprising the steps of:
(i) providing shading correction, pixel sensitivity correction and dark current correction of the outputted signals in proportion to an amount of transmitted light, and
(ii) converting the corrected signals to signals in proportion to image luminance using nonlinear conversion, and
Requirement 1, each of γR₁, γR₂, γG₁, γG₂, γB₁ and γB₂ being from 0.8 to 1.3, and each of |γR₁−γG₁|, |γG₁−γB₁|, |γR₁−γB¹|, |γR₂−γG₂|, |γG₂−γB₂|, and |γR₂−γB₂| being 0.1 or less,
wherein each of γR₁, γG₁ and γB₁ is a gradient of a straight line connecting a point having a density of 0.30 above the minimum transmission density and a point having a density of 1.50 above the minimum transmission density in the red, green and blue light-sensitive layer units respectively, and
each of γR₂, γG₂ and γB₂ is a gradient of a straight line connecting a point having a density of 1.50 above the minimum transmission density and a point having a density of 2.50 above the minimum transmission density in the red, green and blue light-sensitive layer units respectively.

11. The method for forming color images according to claim 10, wherein the silver halide color photographic light sensitive material for image capture comprises a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 320 or more,
wherein the light sensitive material produces an image after being exposed and being subjected to a development processing, the image has characteristic curves of color images formed in the red light-sensitive layer unit, in the green light-sensitive layer unit or in the blue light-sensitive layer unit satisfies Requirement 1, and a spectral absorption maximum of a colored dye formed from a coupling reaction of a cyan coupler contained in the red light-sensitive layer unit with an oxidized aromatic primary amine color developing agent is 630 to 670 nm:
Requirement 1, each of γR₁, γR₂, γG₁, γG₂, γB₁ and γB₂ being from 0.8 to 1.3, and each of |γR₁−γG₁|, |γG₁−γB₁|, |γR₁−γB₁|, |γR₂−γG₂|, |γG₂−γB₂|, and |γR₂−γB₂| being 0.1 or less,
wherein each of γR₁, γG₁ and γB₁ and is a gradient of a straight line connecting a point having a density of 0.30 above the minimum transmission density and a point having a density of 1.50 above the minimum transmission density in the red, green and blue light-sensitive layer units respectively, and
each of γR₂, γG₂ and γB₂ is a gradient of a straight line connecting a point having a density of 1.50 above the minimum transmission density and a point having a density of 2.50 above the minimum transmission density in the red, green and blue light-sensitive layer units respectively.

12. The method for forming color images according to claim 10, wherein the silver halide color photographic light sensitive material for image capture comprises a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 320 or more,
wherein the light sensitive material produces an image after being exposed and being subjected to a development processing, the image has characteristic curves of color images formed in the red light-sensitive layer unit, in the green light-sensitive layer unit or in the blue light-sensitive layer unit satisfies Requirement 1, and each of a minimum transmission density of red, green and blue light is independently 0.20 or less:
Requirement 1, each of γR₁, γR₂, γG₁, γG₂, γB₁ and γB₂ being from 0.8 to 1.3, and each of |γR₁−γG₁|, |γG₁−γB₁|, |γR₁−γB₁|, |γR₂−γG₂|, |γG₂−γB₂|, and |γR₂−γB₂| being 0.1or less,
wherein each of γR₁, γG₁ and γB₁ and is a gradient of a straight line connecting a point having a density of 0.30 above the minimum transmission density and a point having a density of 1.50 above the minimum transmission density in the red, green and blue light-sensitive layer units respectively, and
each of γR₂, γG₂ and γB₂ is a gradient of a straight line connecting a point having a density of 1.50 above the minimum transmission density and a point having a density of 2.50 above the minimum transmission density in the red, green and blue light-sensitive layer units respectively.

13. The method for forming color images according to claim 10, wherein the silver halide color photographic light sensitive material for image capture comprises a transparent substrate having on one surface side thereof, a red light-sensitive layer unit, a green light-sensitive layer unit and a blue light-sensitive layer unit, each light-sensitive layer unit having at least 2layers of the same spectral sensitivity having a different light sensitivity, and a specific photographic sensitivity of the light sensitive material is 320 or more,
wherein the light sensitive material produces an image after being exposed and being subjected to a development processing, the image has characteristic curves of color images formed in the red light-sensitive layer unit, in the green light-sensitive layer unit or in the blue light-sensitive layer unit satisfies Requirement 1, and each of the maximum transmission density of red, green and blue light of the characteristic curves is independently 2.80 to 3.80:
Requirement 1, each of γR₁, γR₂, γG₁, γG₂, γB₁ and γB₂ being from 0.8 to 1.3, and each of |γR₁−γG₁|, |γG₁−γB₁|, |γR₁−γB₁|, |γR₂−γG₂|, |γG₂−γB₂|, and |γR₂−γB₂| being 0.1 or less,
wherein each of γR₁, γG₁ and γB₁ and is a gradient of a straight line connecting a point having a density of 0.30 above the minimum transmission density and a point having a density of 1.50 above the minimum transmission density in the red, green and blue light-sensitive layer units respectively, and
each of γR₂, γG₂ and γB₂ is a gradient of a straight line connecting a point having a density of 1.50 above the minimum transmission density and a point having a density of 2.50 above the minimum transmission density in the red, green and blue light-sensitive layer units respectively.

14. The method for forming color images according to claim 10, wherein the silver halide color photographic light sensitive material for image capture comprises a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 320 or more,
wherein the light sensitive material produces an image after being exposed and being subjected to a development processing, the image has characteristic curves of color images formed in the red light-sensitive layer unit, in the green light-sensitive layer unit or in the blue light-sensitive layer unit satisfies Requirement 1, and each of color separation exposure gradations of γR, γG and γB and white light exposure gradation of γWR, γWG and γWB satisfy Requirement 2:
Requirement 1, each of γR₁, γR₂, γG₁, γG₂, γB₁ and γB₂ being from 0.8 to 1.3, and each of |γR₁−γG₁|, |γG₁−γB₁|, |γR₁−γB₁|, |γR₂−γG₂|, |γG₂−γB₂|, and |γR₂−γB₂| being 0.1 or less,
wherein each of γR₁, γG₁ and γB₁ and is a gradient of a straight line connecting a point having a density of 0.30 above the minimum transmission density and a point having a density of 1.50 above the minimum transmission density in the red, green and blue light-sensitive layer units respectively, and
each of γR₂, γG₂ and γB₂ is a gradient of a straight line connecting a point having a density of 1.50 above the minimum transmission density and a point having a density of 2.50 above the minimum transmission density in the red, green and blue light-sensitive layer units respectively, and
Requirement 2, each of γR/γWR, γG/γWG and γB/γWB being from 1.0 to1.05,
wherein each of γR, γG and γB indicates a gradient of a straight line connecting a point having a density of 0.30 above the minimum transmission density and that of 1.50 above the minimum transmission density in each of the red, green and blue light-sensitive layer units, each straight line of which is obtained by color separation exposure of red, green and blue respectively, and
each of γWR, γWG and γWB indicates a gradient of a straight line connecting a point having a density of 0.30 above the minimum transmission density and 1.50 above the minimum transmission density in each of the red light-sensitive layer unit, green light-sensitive layer unit and blue light-sensitive layer units respectively, of which each straight line is obtained by white light exposure.

15. A method for forming color images according to claim 10, wherein the silver halide color photographic light sensitive material for image capture comprising a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 320 or more,
wherein the light sensitive material produces an image after being exposed and being subjected to a development processing, the image having characteristic curves of color images formed in the red light-sensitive layer unit, in the green light-sensitive layer unit or in the blue light-sensitive layer unit, the characteristic curves satisfying Requirement 1, and each of a minimum transmission density of red, green and blue light of the characteristic curves is independently 0.20 or less, and further each of the characteristic curves of color images formed in the red light-sensitive layer unit, in the green light-sensitive layer unit or in the blue light-sensitive layer unit, the characteristic curves satisfying Requirement 3:
Requirement 1, each of γR₁, γR₂, γG₁, γG₂, γB₁ and γB₂ being from 0.8 to 1.3, and each of |γR₁−γG₁|, |γG₁−γB₁|, |γR₁−γB₁|, |γR₂−γG₂|, |γG₂−65 B₂|, and |γR₂−γB₂| being 0.1 or less,
wherein each of γR₁, γG₁, and γB₁ and is a gradient of a straight line connecting a point having a density of 0.30 above the minimum transmission density and a point having a density of 1.50 above the minimum transmission density in the red, green and blue light-sensitive layer units respectively, and
each of γR₂, γG₂and γB₂is a gradient of a straight line connecting a point having a density of 1.50 above the minimum transmission density and a point having a density of 2.50 above the minimum transmission density in the red, green and blue light-sensitive layer units respectively, and
Requirement 3, each of γR3, γG3 and γB3 being from 0.8 to 1.3,
wherein each of γR₃, γG₃ and γB₃ is a gradient of a straight line connecting a point having a density of 0.70 above the minimum transmission density and a point having a density of 2.00 above the minimum transmission density in the red, green and blue light-sensitive layer units respectively.

16. The method for forming color images according to claim 10, wherein the silver halide color photographic light sensitive material for image capture comprising a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 320 or more,
wherein the light sensitive material produces an image after being exposed and being subjected to a development processing, the image having characteristic curves of color images formed in the red light-sensitive layer unit, in the green light-sensitive layer unit or in the blue light-sensitive layer unit, the characteristic curves satisfying Requirement 1, and each of a maximum transmission density of red, green and blue light is independently 2.80 to 3.80, and further each of the characteristic curves of color images formed in the red light-sensitive layer unit, in the green light-sensitive layer unit or in the blue light-sensitive layer unit, satisfying Requirement 3:
Requirement 1, each of γR₁, γR₂, γG₁, γG₂, γB₁ and γB₂ being from 0.8 to 1.3, and each of |γR₁−γG₁|, |γG₁−γB₁|, |γR₁−γB₁|, |γR₂−γG₂|, |γG₂−γB₂|, and |γR₂−γB₂| being 0.1 or less,
wherein each of γR₁, γG₁ and γB₁ and is a gradient of a straight line connecting a point having a density of 0.30 above the minimum transmission density and a point having a density of 1.50 above the minimum transmission density in the red, green and blue light-sensitive layer units respectively, and
each of γR₂, γG₂ and γB₂ is a gradient of a straight line connecting a point having a density of 1.50 above the minimum transmission density and a point having a density of 2.50 above the minimum transmission density in the red, green and blue light-sensitive layer units respectively, and Requirement 3, each of γR3, γG3 and γB3 being from 0.8 to 1.3,
wherein each of γR₃, γG₃ and γB₃ is a gradient of a straight line connecting a point having a density of 0.70 above the minimum transmission density and a point having a density of 2.00 above the minimum transmission density in the red, green and blue light-sensitive layer units respectively.

17. The method for forming color images according to claim 10, wherein the silver halide color photographic light sensitive material for image capture comprising a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 320 or more,
wherein the light sensitive material produces an image after being exposed and being subjected to a development processing, the image having characteristic curves of color images formed in the red light-sensitive layer unit, in the green light-sensitive layer unit or in the blue light-sensitive layer unit, the characteristic curves satisfying Requirement 1, and each of the maximum transmission density of red, green and blue light of the characteristic curves is independently 2.80 to 3.80, and further each of the characteristic curves of color images formed in the red light-sensitive layer unit, in the green light-sensitive layer unit or in the blue light-sensitive layer unit, satisfying Requirement 3:
Requirement 1, each of γR₁, γR₂, γG₁, γG₂, γB₁ and γB₂ being from 0.8 to 1.3, and each of |γR₁−γG₁|, |γG₁−γB₁|, |γR₁−γB1|, |γR₂−γG₂|, |γG₂−γB₂|, and |γR₂−γB₂| being 0.1 or less,
wherein each of γR₁, γG₁ and γB₁ and is a gradient of a straight line connecting a point having a density of 0.30 above the minimum transmission density and a point having a density of 1.50 above the minimum transmission density in the red, green and blue light-sensitive layer units respectively, and
each of γR₂, γG₂ and γB₂ is a gradient of a straight line connecting a point having a density of 1.50 above the minimum transmission density and a point having a density of 2.50 above the minimum transmission density in the red, green and blue light-sensitive layer units respectively, and
Requirement 3, each of γR3, γG3 and γB3 being from 0.8 to 1.3,
wherein each of γR₃, γG₃ and γB₃ is a gradient of a straight line connecting a point having a density of 0.70 above the minimum transmission density and a point having a density of 2.00 above the minimum transmission density in the red, green and blue light-sensitive layer units respectively.

18. The method for forming color images according to claim 10, wherein the silver halide color photographic light sensitive material for image capture comprising a transparent substrate having on one surface side thereof, a red light-sensitive layer unit, a green light-sensitive layer unit and a blue light-sensitive layer unit, each light-sensitive layer unit having at least 2 layers of the same spectral sensitivity having a different light sensitivity, and a specific photographic sensitivity of the light sensitive material is 320 or more,
wherein the light sensitive material produces an image after being exposed and being subjected to a development processing, the image having characteristic curves of color images formed in the red light-sensitive layer unit, in the green light-sensitive layer unit or in the blue light-sensitive layer unit, the characteristic curves satisfying Requirement 1, and each of color separation exposure gradations of γR, γG and γB and white light exposure gradation of γWR, γWG and γWB satisfy Requirement 2, and further each of the characteristic curves of color images formed in the red light-sensitive layer unit, in the green light-sensitive layer unit or in the blue light-sensitive layer unit, satisfying Requirement 3:
Requirement 1, each of γR₁, γR₂, γG₁, γG₂, γB₁ and γB₂
being from 0.8 to 1.3, and each of |γR₁−γG₁|, |γG₁−γB₁|, |γR₁−γB₁|, |γR₂−γG₂|, |γG₂−γB₂|, and |γR₂−γB₂| being 0.1 or less,
wherein each of γR₁, γG₁ and γB₁ and is a gradient of a straight line connecting a point having a density of 0.30 above the minimum transmission density and a point having a density of 1.50 above the minimum transmission density in the red, green and blue light-sensitive layer units respectively, and
each of γR₂, γG₂ and γB₂ is a gradient of a straight line connecting a point having a density of 1.50 above the minimum transmission density and a point having a density of 2.50 above the minimum transmission density in the red, green and blue light-sensitive layer units respectively, and
Requirement 2, each of γR/γWR, γG/γWG and γB/γWB being from 1.0 to1.05,
wherein each of γR, γG and γB indicates a gradient of a straight line connecting a point having a density of 0.30 above the minimum transmission density and a point having a density of 1.50 above the minimum transmission density in each of the red, green and blue light-sensitive layer units, each straight line of which is obtained by color separation exposure of red, green and blue respectively, and
each of γWR, γWG and γWB indicates a gradient of a straight line connecting a point having a density of 0.30 above the minimum transmission density and a point having a density 1.50 above the minimum transmission density in each of the red light-sensitive layer unit, green light-sensitive layer unit and blue light-sensitive layer units respectively, of which each straight line is obtained by white light exposure, and
Requirement 3, each of γR3, γG3 and γB3 being from 0.8 to 1.3,
wherein each of γR₃, γG₃ and γB₃ is a gradient of a straight line connecting a point having a density of 0.70 above the minimum transmission density and a point having a density of 2.00 above the minimum transmission density in the red, green and blue light-sensitive layer units respectively.
